(19) United States
(12) Patent Application Publication
(10) Pub. No.: US 2009/0091180 A1
(43) Pub. Date: Apr. 9, 2009

(54) BRAKE CONTROL APPARATUS, AND PROCESS OF OPERATING THE SAME

(75) Inventors: Katsuya Iwasaki, Isehara-shi (JP); Norihiro Saita, Atsugi-shi (JP); Hitoshi Kobayashi, Tokyo (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/244,153

(22) Filed: Oct. 2, 2008

(30) Foreign Application Priority Data
Oct. 3, 2007 (JP) 2007-259522

(51) Int. Cl. B60T 13/16; G06F 17/00

(52) U.S. Cl. 303/11; 701/71

(57) ABSTRACT

In a brake control apparatus, a fluid passage section is hydraulically connected between a hydraulic pressure source and a wheel cylinder. A first pressure sensor measures a first quantity correlated to a hydraulic pressure outputted by the hydraulic pressure source. A second pressure sensor measures a second quantity correlated to an internal pressure of the wheel cylinder. A controller controls a braking force of a wheel by the wheel cylinder. The controller is configured to: allow the first pressure sensor to obtain a value of the first quantity, and allow the second pressure sensor to obtain a value of the second quantity, while allowing a selector to regulate fluid communication between the hydraulic pressure source and the wheel cylinder; and calibrate the first and second pressure sensors with respect to each other in accordance with the obtained values of the first and second quantities.

### BACKGROUND OF THE INVENTION

The present invention relates generally to brake control apparatuses for wheeled vehicles, and more particularly to a brake control apparatus provided with a brake-by-wire system for controlling the internal pressures of wheel cylinders so as to produce braking forces.

Japanese Patent Application Publication No. 2005-47384 discloses a brake control apparatus in which fluid communication between a brake pedal and a set of wheel cylinders is blocked, and wheel cylinder pressures are controlled by computing desired wheel cylinder pressures on the basis of data signals from a brake pedal stroke sensor and a master cylinder pressure sensor, and operating an electric motor for driving a hydraulic pump and electromagnetic valves in accordance with the computed desired wheel cylinder pressures.

### SUMMARY OF THE INVENTION

The brake control apparatus of Japanese Patent Application Publication No. 2005-47384 may encounter a phenomena that a single hydraulic pressure is measured as different values by different pressure sensors due to individual errors contained in measured quantity values. Such a phenomena may cause an undesirable imbalance among wheel cylinder pressures which are controlled with feedback of measured wheel cylinder pressures including errors, and thereby cause dynamic behavior of a subject vehicle to fall unstable.

In view of the foregoing, it is desirable to provide a brake control apparatus capable of more accurately controlling wheel cylinder pressures while canceling variation among pressure sensors.

According to one aspect of the present invention, a brake control apparatus comprises: a hydraulic pressure source arranged to output a hydraulic pressure; a wheel cylinder adapted to a wheel; a fluid passage section hydraulically connected between the hydraulic pressure source and the wheel cylinder; a selector arranged to regulate fluid communication through the fluid passage section between the hydraulic pressure source and the wheel cylinder; a first pressure sensor arranged to measure a first quantity correlated to the hydraulic pressure outputted by the hydraulic pressure source; a second pressure sensor arranged to measure a second quantity correlated to an internal pressure of the wheel cylinder; and a controller for controlling a braking force of the wheel by the wheel cylinder, the controller being configured to: allow the first pressure sensor to obtain a value of the first quantity, and allow the second pressure sensor to obtain a value of the second quantity, while allowing the selector to regulate fluid communication between the hydraulic pressure source and the wheel cylinder; and calibrate the first and second pressure sensors with respect to each other in accordance with the obtained values of the first and second quantities.

According to another aspect of the present invention, a process of operating a brake control apparatus after mounting a hydraulic actuator to a vehicle, the brake control apparatus including: a master cylinder; a first wheel cylinder adapted to a first wheel of the vehicle; a second wheel cylinder adapted to a second wheel of the vehicle; a hydraulic pump arranged to output a hydraulic pressure independently of the master cylinder; the hydraulic actuator including: a first fluid passage hydraulically connected between the master cylinder and the first wheel cylinder; a second fluid passage hydraulically connected between the hydraulic pump and the first wheel cylinder; a third fluid passage hydraulically connected between the hydraulic pump and the second wheel cylinder; a fourth fluid passage hydraulically connected between the first wheel cylinder and a reservoir; a fifth fluid passage hydraulically connected between the second wheel cylinder and the reservoir; a shut-off valve arranged in the first fluid passage; a first inlet valve arranged in the second fluid passage; a second inlet valve arranged in the third fluid passage; a first outlet valve arranged in the fourth fluid passage; and a second outlet valve arranged in the fifth fluid passage; a first pressure sensor arranged to measure a first quantity correlated to an internal pressure of the first wheel cylinder; a second pressure sensor arranged to measure a second quantity correlated to an internal pressure of the second wheel cylinder; and a controller configured to control the internal pressures of the first and second wheel cylinders by the hydraulic pump and the hydraulic actuator so as to control braking forces of the first and second wheels, the process comprises: establishing a first condition by opening the shut-off valve, closing the first and second inlet valves, closing the first and second outlet valves, and allowing the master cylinder to be pressurized, so as to generate a hydraulic pressure in the first fluid passage; calibrating the first pressure sensor under the first condition; establishing a second condition by closing the shut-off valve, opening the first and second inlet valves, closing the first and second outlet valves, and driving the hydraulic pump, so as to generate a hydraulic pressure in the second and third fluid passages; allowing the second pressure sensor to obtain a value of the second quantity under the second condition; and calibrating the second pressure sensor with respect to the first pressure sensor in accordance with the obtained value of the second quantity.

According to a further aspect of the present invention, a process of operating a brake control apparatus, the brake control apparatus including: a master cylinder; a first wheel cylinder adapted to a first wheel of a vehicle; a second wheel cylinder adapted to a second wheel of the vehicle; a hydraulic pump arranged to output a hydraulic pressure independently of the master cylinder; a hydraulic actuator including: a first fluid passage hydraulically connected between the master cylinder and the first wheel cylinder; a second fluid passage hydraulically connected between the hydraulic pump and the first wheel cylinder; a third fluid passage hydraulically connected between the hydraulic pump and the second wheel cylinder; a fourth fluid passage hydraulically connected between the first wheel cylinder and a reservoir; a fifth fluid passage hydraulically connected between the second wheel cylinder and the reservoir; a shut-off valve arranged in the first fluid passage; a first inlet valve arranged in the second fluid passage; a second inlet valve arranged in the third fluid passage; a first outlet valve arranged in the fourth fluid passage; and a second outlet valve arranged in the fifth fluid passage; a first pressure sensor arranged to measure a first quantity correlated to an internal pressure of the first wheel cylinder; a second pressure sensor arranged to measure a second quantity correlated to an internal pressure of the second wheel cylinder; and a controller configured to control the internal pressures of the first and second wheel cylinders by the hydraulic pump and the hydraulic actuator so as to control braking forces of the first and second wheels, the process comprises: establishing a first condition by closing the shut-off valve, opening the first and second inlet valves, closing the first and second outlet valves, and driving the hydraulic pump, so as to generate a hydraulic pressure in the second and third fluid passages, before mounting the hydraulic actuator to the vehicle; allowing the first pressure sensor to obtain a value of the first quantity under the first condition, and allowing the second pressure sensor to obtain a value of the second quantity under the first condition; calibrating the first and second pressure sensors with respect to each other in accordance with the obtained values of the first and second quantities; establishing a second condition by opening the shut-off valve, closing the first and second inlet valves, closing the first and second outlet valves, and allowing the first fluid passage to be pressurized; allowing the first pressure sensor to obtain a second value of the first quantity under the second condition; and recalibrating the first and second pressure sensors in accordance with the second value of the first quantity.

According to a still further aspect of the present invention, a process of operating a brake control apparatus, the brake control apparatus including: a master cylinder; a first wheel cylinder adapted to a front left wheel of a vehicle; a second wheel cylinder adapted to a front right wheel of the vehicle; a first hydraulic pump arranged to output a hydraulic pressure independently of the master cylinder; a second hydraulic pump arranged to output a hydraulic pressure independently of the master cylinder; a first hydraulic actuator including: a first fluid passage hydraulically connected between the master cylinder and the first wheel cylinder, wherein the first hydraulic actuator receives a first hydraulic pressure from the master cylinder through the first fluid passage; a second fluid passage hydraulically connected between the first hydraulic pump and the first wheel cylinder; a third fluid passage hydraulically connected between the first wheel cylinder and a reservoir; a first shut-off valve arranged in the first fluid passage; a first inlet valve arranged in the second fluid passage; and a first outlet valve arranged in the third fluid passage; a second hydraulic actuator including: a fourth fluid passage hydraulically connected between the master cylinder and the second wheel cylinder, wherein the second hydraulic actuator receives a second hydraulic pressure from the master cylinder through the fourth fluid passage, and the second hydraulic pressure is equal to the first hydraulic pressure; a fifth fluid passage hydraulically connected between the second hydraulic pump and the second wheel cylinder; a sixth fluid passage hydraulically connected between the second wheel cylinder and the reservoir; a second shut-off valve arranged in the fourth fluid passage; a second inlet valve arranged in the fifth fluid passage; and a second outlet valve arranged in the sixth fluid passage; a first pressure sensor arranged in the first fluid passage for measuring the first hydraulic pressure; a second pressure sensor arranged in the fourth fluid passage for measuring the second hydraulic pressure; and a controller configured to control the internal pressures of the first and second wheel cylinders by the hydraulic pump and the first and second hydraulic actuators so as to control braking forces of the front left and right wheels, the process comprises: determining whether or not the first pressure sensor is failed; controlling the first and second hydraulic actuators on a basis of measurement of the second pressure sensor, in response to determining that the first pressure sensor is failed; determining whether or not the second pressure sensor is failed; and controlling the first and second hydraulic actuators on a basis of measurement of the first pressure sensor, in response to determining that the second pressure sensor is failed.

### BRIEF DESCRIPTION OF THE DRAWINGS

FIG. 1 is a schematic diagram showing a configuration of a brake control apparatus for an automotive vehicle according to a first embodiment of the present invention.

FIG. 2 is a schematic diagram showing a hydraulic circuit of a first hydraulic unit in the brake control apparatus according to the first embodiment.

FIG. 3 is a schematic diagram showing a hydraulic circuit of a second hydraulic unit in the brake control apparatus according to the first embodiment.

FIG. 4 is a flow chart showing a process of brake-by-wire control to be performed by the brake control apparatus according to the first embodiment.

FIG. 5 is a flow chart showing a process of controlling a selector valve provided for a stroke simulator in the brake control apparatus according to the first embodiment.

FIG. 6 is a graphic diagram showing a process of calibration for pressure sensors provided in the brake control apparatus according to the first embodiment.

FIG. 7 is a graphic diagram showing a relationship between an actual pressure value P and a measured quantity value D in each of the pressure sensors provided in the brake control apparatus according to the first embodiment.

FIG. 8 is a flow chart showing a process of obtaining measured hydraulic pressures in the brake control apparatus according to the first embodiment.

FIG. 9 is a flow chart showing a main process of calibration to be performed by the brake control apparatus according to the first embodiment.

FIG. 10 is a flow chart showing a process of calibration of front left and right wheel cylinder pressure sensors provided in the brake control apparatus according to the first embodiment.

FIG. 11 is a flow chart showing a process of calibration of a rear left wheel cylinder pressure sensor and a second pump discharge pressure sensor provided in the brake control apparatus according to the first embodiment.

FIG. 12 is a flow chart showing a main process of calibration to be performed by a brake control apparatus for an automotive vehicle according to a second embodiment of the present invention before and after first and second hydraulic units of the brake control apparatus are mounted to the vehicle.

FIG. 13 is a flow chart showing a process of calibration to be performed by the brake control apparatus according to the second embodiment before the second hydraulic unit of the brake control apparatus is mounted to the vehicle.

FIG. 14 is a flow chart showing a process of calibration to be performed by the brake control apparatus according to the second embodiment after the first and second hydraulic units of the brake control apparatus are mounted to the vehicle.

FIG. 15 is a schematic diagram showing a configuration of a brake control apparatus for an automotive vehicle according to a modification of the first embodiment.

FIG. 16 is a schematic diagram showing a hydraulic circuit of a first hydraulic unit provided in a brake control apparatus for an automotive vehicle according to another modification of the first embodiment.

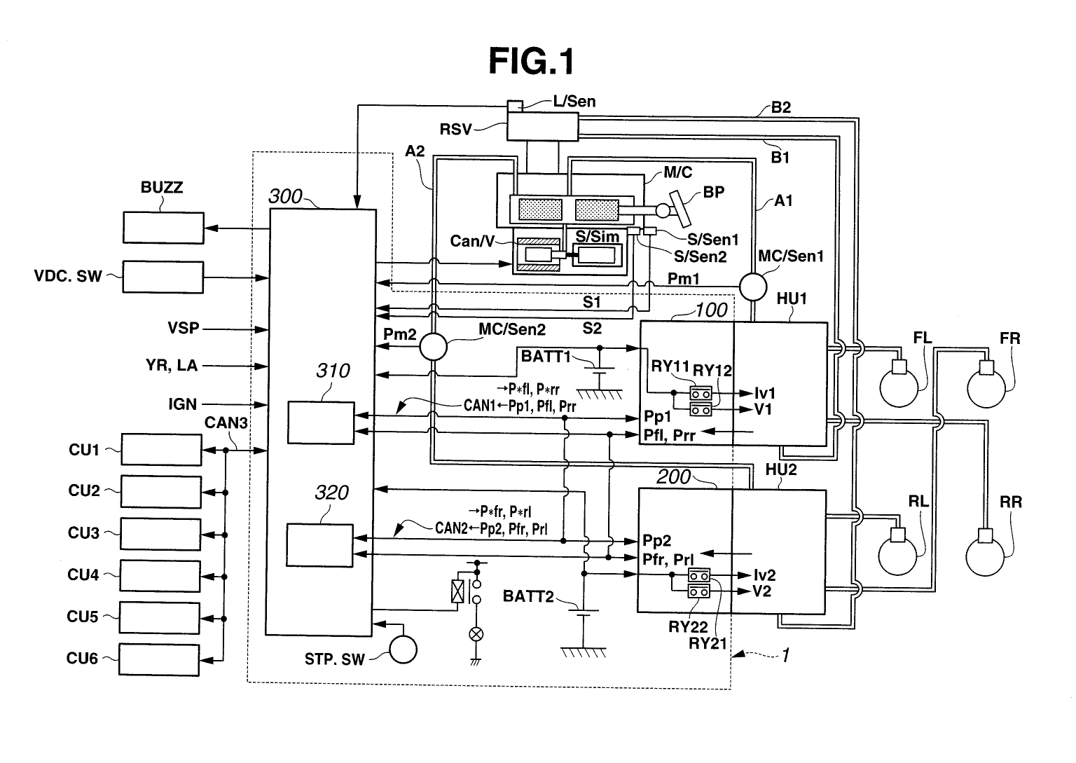

### DETAILED DESCRIPTION OF THE INVENTION

[System Configuration] The following describes a brake control apparatus for an automotive vehicle according to a first embodiment of the present invention with reference to FIGS. 1 to 11. FIG. 1 schematically shows a configuration of the brake control apparatus according to the first embodiment. The vehicle includes four road wheels, i.e. a front left wheel “FL”, a front right wheel “FR”, a rear left wheel “RL” and a rear right wheel “RR”. The brake control apparatus is provided with a four-wheel brake-by-wire system. The brake control apparatus includes first and second hydraulic units “HU1” and “HU2” as hydraulic actuators which are capable of controlling internal pressures of wheel cylinders adapted to wheels FL, FR, RL and RR, independently of manipulation of a brake pedal “BP”.

The brake control apparatus includes a control section 1 including a high-level main electrical control unit (ECU) 300 as a main unit, and low-level first and second sub electrical control units (ECUs) 100 and 200 as sub units. Main ECU 300 implements a function of computing desired wheel cylinder pressures P*fl, P*fr, P*rl and P*rr of wheels FL, FR, RL and RR. First and second sub ECUs 100 and 200 implement functions of controlling first and second hydraulic units HU1 and HU2 in accordance with control signals outputted from main ECU 300. Control section 1 or main ECU 300 thus serves as a controller for controlling braking forces of wheels by wheel cylinders.

A stroke simulator “S/Sim”, which is hydraulically connected to a master cylinder “M/C”, applies a feedback force to brake pedal BP.

Master cylinder M/C is of a tandem type, and generates identical hydraulic pressures in fluid passages “A1” and “A2” in accordance with depression of brake pedal BP.

First and second hydraulic units HU1 and HU2 are hydraulically connected to master cylinder M/C through fluid passages A1 and A2, respectively, and hydraulically connected to a reservoir “RSV” through fluid passages “B1” and “B2”, respectively. Fluid passages A1 and A2 are provided with first and second master cylinder pressure sensors “MC/Sen1” and “MC/Sen2”, respectively.

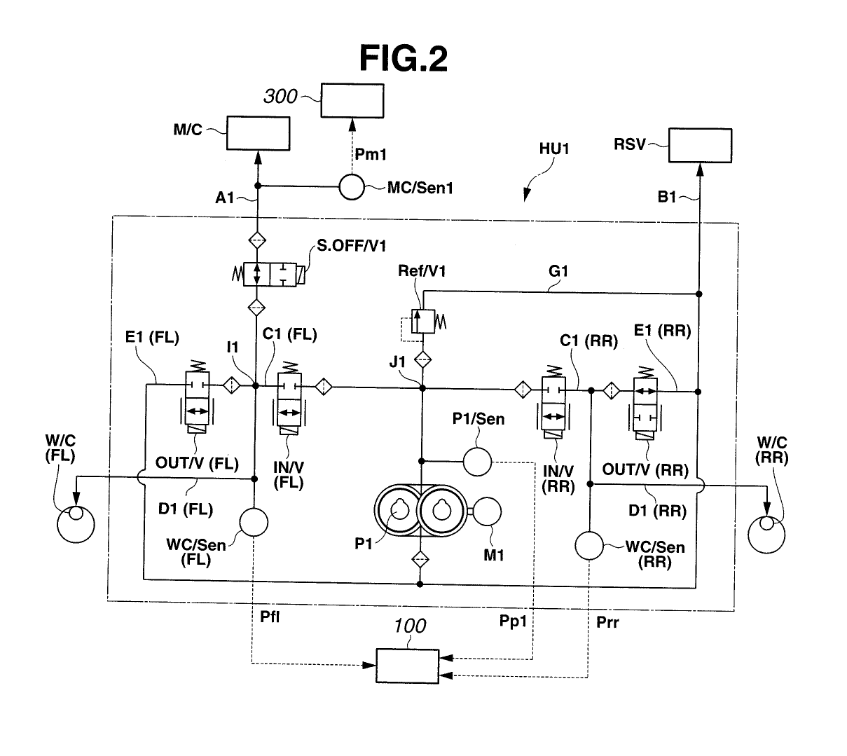

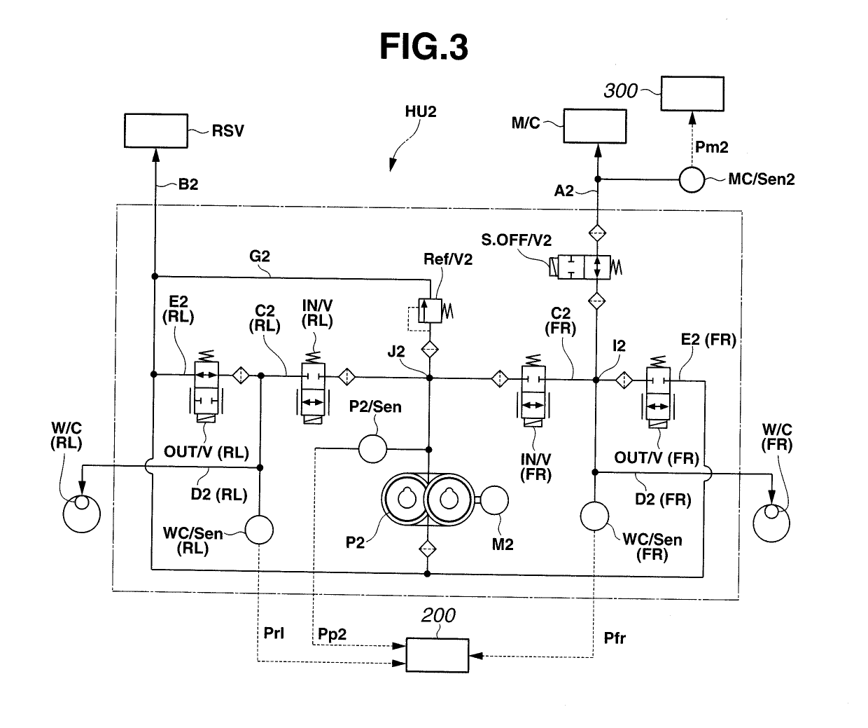

Each of first and second hydraulic units HU1 and HU2 is a hydraulic actuator for generating and regulating internal pressures of wheel cylinders, independently of each other, including a hydraulic pump “P1” or “P2”, an electric motor “M1” or “M2”, and electromagnetic valves, as shown in FIGS. 2 and 3. First hydraulic unit HU1 performs a fluid pressure control for front left and rear right wheels FL and RR, while second hydraulic unit HU2 performs a fluid pressure control for front right and rear left wheels FR and RL.

Specifically, hydraulic pumps P1 and P2 directly pressurize four wheel cylinders, i.e. a front left wheel cylinder “W/C(FL)” for front left wheel FL, a front right wheel cylinder “W/C(FR)” for front right wheel FR, a rear left wheel cylinder “W/C(RL)” for rear left wheel RL, and a rear right wheel cylinder “W/C(RR)” for rear right wheel RR. Each of hydraulic pumps P1 and P2 thus serves as a hydraulic pressure source arranged to generate and output a hydraulic pressure independently of master cylinder M/C. Since wheel cylinders W/C(FL) to W/C(RR) are pressurized directly by hydraulic pumps P1 and P2 with no accumulator, there is no possibility that a gas in such an accumulator leaks into a fluid passage under a failed condition. Hydraulic pump P1 serves for pressure increase for front left and rear right wheels FL and RR, and hydraulic pump P2 serves for pressure increase for front right and rear left wheels FR and RL, constituting so called an X-pipe arrangement.

First and second hydraulic units HU1 and HU2 are provided separately from each other. The separate provision allows one hydraulic unit to generate a braking effort, even when the other hydraulic unit is failed, for example, subject to leaking. However, first and second hydraulic units HU1 and HU2 are not so limited, but may be provided as a unit so as to collect electric circuit configurations at one place, shorten harnesses, etc., and thus simplify the layout.

A small number of hydraulic pressure sources are desired for the compactness of the brake control apparatus. However, in the case of a single hydraulic pressure source, there is no backup when the hydraulic pressure source is failed. On the other hand, in the case of four hydraulic pressure sources for respective wheels, it is advantageous against failures, but the device is large-sized, and difficult to control. A brake-by-wire control requires a redundant system. Such a system may diverge with an increase in the number of hydraulic pressure sources.

Currently, brake fluid passages of vehicles are generally in the form of X-pipe arrangement in which a pair of diagonally opposite wheels (FL-RR or FR-RL) are connected to each other through a fluid passage, and each system is pressurized by a separate hydraulic pressure source (tandem-type master cylinder, etc.). Thus, even when one pair of diagonally opposite wheels are failed, the other pair of diagonally opposite wheels can generate a braking effort while preventing the braking effort from leaning to one of the left and right sides. Therefore, the number of hydraulic pressure sources is assumed to be two in general.

Naturally, in the case of a single hydraulic pressure source, no X-pipe arrangement is possible. Also, in the case of three or four hydraulic pressure sources, each pair of diagonally opposite wheels are not connected by a single hydraulic pressure source, no X-pipe arrangement is possible.

Therefore, in order to improve anti-fail performance while employing widely-used X-pipe arrangement with no modification, the brake control apparatus according to the present embodiment includes two hydraulic units HU1 and HU2 having hydraulic pumps P1 and P2 as hydraulic pressure sources.

When a vehicle is under braking, it is difficult to depend largely on the braking effort of rear wheels, because a larger load is applied to front wheels. A large braking effort of rear wheels may cause a spin. Accordingly, in general, braking effort is distributed relatively largely to front wheels, for example, 2 part to front wheels and 1 part to rear wheels.

When a plurality of hydraulic systems are provided in a vehicle in order to enhance anti-fail performance, it is desired that the hydraulic systems have identical specifications in view of manufacturing cost. In case four hydraulic systems are provided to four wheels, respectively, two sets of hydraulic systems having different specifications are necessary in consideration of front-rear braking effort distribution as described above. This increases the total manufacturing cost. This is true for cases where three hydraulic systems are provided in a vehicle.

According to the present embodiment, first and second hydraulic units HU1 and HU2 in X-pipe arrangement are each configured to supply 2 part to front wheels and 1 part to rear wheels. The ratio of distribution is set by adjusting valve openings in each of first and second hydraulic units HU1 and HU2. First and second hydraulic units HU1 and HU2 are identical to each other. This is effective for reduction in manufacturing cost.

[Main ECU] Main ECU 300 is a high-level CPU for computing desired wheel cylinder pressures P*fl to P*rr which are to be generated by first and second hydraulic units HU1 and HU2. Main ECU 300 is electrically connected to first and second power supplies “BATT1” and “BATT2” so that main ECU 300 is capable of operating when at least one of BATT1 and BATT2 is normal. Main ECU 300 is started up in response to an ignition signal “IGN” or in response to a startup request from other control units “CU1”, “CU2”, “CU3”, “CU4”, “CU5” and “CU6”.

Main ECU 300 receives stroke signals “S1” and “S2” from first and second stroke sensors “S/Sen1” and “S/Sen2”, where first and second stroke signals S1 and S2 are indicative of an amount of stroke of brake pedal BP. Main ECU 300 also receives data signals indicative of first and second measured master cylinder pressures “Pm1” and “Pm2” from first and second master cylinder pressure sensors MC/Sen1 and MC/Sen2.

Also, main ECU 300 receives data signals indicative of a wheel speed “VSP”, a yaw rate “YR” and a vehicle longitudinal acceleration “LA”. Moreover, main ECU 300 receives a data signal from a fluid amount sensor “L/Sen” provided in reservoir RSV. Main ECU 300 judges whether or not it is possible to perform a brake-by-wire control based on hydraulic pump drive. Manipulation of brake pedal BP is detected based on a signal from a stop lamp switch “STP.SW”, not based on stroke signals S1 and S2 and first and second measured master cylinder pressures Pm1 and Pm2.

Main ECU 300 includes first and second CPUs 310 and 320. First and second CPUs 310 and 320 are respectively electrically connected to first and second sub ECUs 100 and 200 through CAN communication lines CAN1 and CAN2. First and second sub ECUs 100 and 200 output data signals indicative of hydraulic pump discharge pressures “Pp1” and “Pp2”, and measured wheel cylinder pressures “Pfl”, “Pfr”, “Prl” and “Prr”, to first and second CPUs 310 and 320. CAN communication lines CAN1 and CAN2 are electrically connected to each other for bidirectional communication, and are each in the form of a redundant system for backup.

On the basis of the inputted stroke signals S1 and S2, first and second measured master cylinder pressures Pm1 and Pm2, and actual wheel cylinder pressures Pfl to Prr, first and second CPUs 310 and 320 compute desired wheel cylinder pressures P*fl to P*rr, and then output them to sub ECUs 100 and 200 through CAN communication lines CAN1 and CAN2.

Alternatively, desired wheel cylinder pressures P*fl to P*rr for first and second hydraulic units HU1 and HU2 may be computed only by first CPU 310, while second CPU 320 may serve as a backup for first CPU 310.

Main ECU 300 starts sub ECUs 100 and 200 by issuing respective starting signals to first and second sub ECUs 100 and 200 through CAN communication lines CAN1 and CAN2. Main ECU 300 may be configured to issue a single starting signal to first and second sub ECUs 100 and 200 so that both of first and second sub ECUs 100 and 200 start up. First and second sub ECUs 100 and 200 may be started in response to ignition signal IGN.

During vehicle behavior controls such as ABS (control of increase and reduction in braking effort for preventing vehicle wheels from locking up), VDC (control of increase and reduction in braking effort for preventing side slips under disturbance of vehicle behavior), and TCS (control of preventing driving wheels from slipping), main ECU 300 computes desired wheel cylinder pressures P*fl to P*rr also on the basis of wheel speed VSP, yaw rate YR and vehicle longitudinal acceleration LA. During the VDC control, a buzzer “BUZZ” warns a driver. A driver can operate a VDC switch “VDC.SW” to turn on or off the VDC control.

Main ECU 300 is electrically connected to other control units CU1, CU2, CU3, CU4, CU5 and CU6 through CAN communication line CAN3 so that main ECU 300 performs a cooperative control. Regenerative braking control unit CU1 regenerates braking effort into electric energy. Radar control unit CU2 controls vehicle-to-vehicle distance. EPS control unit CU3 is a control unit of an electric power steering system.

ECM control unit CU4 is a control unit of an engine. AT control unit CU5 is a control unit of an automatic transmission. Meter control unit CU6 controls meters. Main ECU 300 relays a data signal indicative of wheel speed VSP through CAN communication line CAN3 to ECM control unit CU4, AT control unit CU5 and meter control unit CU6.

ECUs 100, 200 and 300 receive electric power from first and second power supplies BATT1 and BATT2. First power supply BATT1 is electrically connected to main ECU 300 and first sub ECU 100. Second power supply BATT2 is electrically connected to main ECU 300 and second sub ECU 200.

[Sub ECUs] First and second sub ECUs 100 and 200 are formed integrally with first and second hydraulic units HU1 and HU2, respectively. Alternatively, first and second sub ECUs 100 and 200 may be formed separately from first and second hydraulic units HU1 and HU2, respectively, in order to conform to the layout of the vehicle.

First and second sub ECUs 100 and 200 receive data signals indicative of desired wheel cylinder pressures P*fl to P*rr from main ECU 300, and receive data signals indicative of hydraulic pump discharge pressures Pp1 and Pp2 of first and second hydraulic pumps P1 and P2 and actual wheel cylinder pressures Pfl and Prr, and Pfr and Prl from first and second hydraulic units HU1 and HU2.

First and second sub ECUs 100 and 200 perform fluid pressure control by operating hydraulic pumps P1 and P2, electric motors M1 and M2, and the electromagnetic valves in first and second hydraulic units HU1 and HU2, based on the inputted pump discharge pressures Pp1 and Pp2 and actual wheel cylinder pressures Pfl to Prr, in order to attain desired wheel cylinder pressures P*fl to P*rr.

Until the current values of desired wheel cylinder pressures P*fl to P*rr are replaced by new values of desired wheel cylinder pressures P*fl to P*rr, first and second sub ECUs 100 and 200 perform a servo control of converging wheel cylinder pressures Pfl, Pfr, Prl and Prr to the current values of desired wheel cylinder pressures P*fl, P*fr, P*rl and P*rr.

First and second sub ECUs 100 and 200 convert the electric power supplied from power supplies BATT1 and BATT2 into valve drive currents “Iv1” and “Iv2” and motor drive voltages “V1” and “V2” for first and second hydraulic units HU1 and HU2, and then outputs them to first and second hydraulic units HU1 and HU2 through relays “RY11” and “RY12”, and relays “RY21” and “RY22”, respectively.

[Separation Between Computation and Drive Control] Main ECU 300 computes desired wheel cylinder pressures P*fl, P*fr, P*rl and P*rr, but does not directly control operation of first and second hydraulic units HU1 and HU2. However, it can be considered that main ECU 300 is configured to compute desired wheel cylinder pressures P*fl, P*fr, P*rl and P*rr, and directly control first and second hydraulic units HU1 and HU2. In such a case, main ECU 300 cooperates with the other control units CU1, CU2, CU3, CU4, CU5 and CU6 through CAN communication line CAN3 to output drive commands to first and second hydraulic units HU1 and HU2. Thus, main ECU 300 outputs drive commands to first and second hydraulic units HU1 and HU2 after completion of signal communication through CAN communication line CAN3 and computation in control units CU1, CU2, CU3, CU4, CU5 and CU6. Therefore, if signal communication through CAN communication line CAN3 and computation in control units CU1, CU2, CU3, CU4, CUS and CU6 take much time, the braking control is subject to delays. Increase in communication speed of CAN communication line CAN3 tends to increase the cost thereof, and to affect adversely the anti-fail performance against noise.

For the reasons described above, main ECU 300 according to the eighth embodiment serves only to compute desired wheel cylinder pressures P*fl to P*rr for first and second hydraulic units HU1 and HU2, while the drive control of first and second hydraulic units HU1 and HU2 are performed by first and second sub ECUs 100 and 200 having the servo control system. Thus, first and second sub ECUs 100 and 200 handle the control of first and second hydraulic units HU1 and HU2, while main ECU 300 handles cooperative control between control units CU1, CU2, CU3, CU4, CU5 and CU6. This is effective for bring operation of first and second hydraulic units HU1 and HU2 under no influence of speed of signal communication through CAN communication line CAN3 and computation in control units CU1, CU2, CU3, CU4, CU5 and CU6.

According to the foregoing configuration in which main ECU 300 cooperates with first and second sub ECUs 100 and 200, even when there are added various units such as a regeneration cooperative brake system, a vehicle integrated control, and an ITS, which are in general necessary for hybrid vehicles and fuel cell vehicles, the brake control system is controlled independently of other controls systems so as to ensure the responsiveness of the brake control in conformance with these units. The foregoing configuration in which main ECU 300 cooperates with first and second sub ECUs 100 and 200 is advantageous, especially because such a brake-by-wire system as described in the present embodiments requires an elaborate control based on the amount of operation of a brake pedal during normal braking that is frequently employed.

[Master Cylinder and Stroke Simulator] Stroke simulator S/Sim is mounted in master cylinder M/C for generating a feedback force to brake pedal BP. Master cylinder M/C includes a selector valve “Can/V” for selectively allowing or inhibiting fluid communication between master cylinder M/C and stroke simulator S/Sim. Selector valve Can/V is opened or closed by main ECU 300. When the brake-by-wire system is terminated, or when sub ECUs 100 and 200 are failed, then selector valve Can/V is quickly closed so that the brake control apparatus enters manual braking mode. Master cylinder M/C includes first and second stroke sensors S/Sen1 and S/Sen2 for measuring the stroke of brake pedal BP, and outputting stroke signals S1 and S2 to main ECU 300.

[Hydraulic Unit] The following describes first and second hydraulic units HU1 and HU2 in detail with reference to FIGS. 2 and 3. First hydraulic unit HU1 includes a shut-off valve “S.OFF/V1”, front left and rear right inlet valves “IN/V(FL) and IN/V(RR)” and front left and rear right outlet valves “OUT/V(FL)” and “OUT/V(RR)”, hydraulic pump P1, and electric motor M1.

Hydraulic pump P1 includes a discharge port hydraulically connected through fluid passages “C1(FL)” and “C1(RR)” to front left and rear right wheel cylinders W/C(FL) and W/C(RR), and a suction port hydraulically connected through fluid passage B1 to reservoir RSV. Fluid passages C1(FL) and C1(RR) are hydraulically connected to fluid passage B1 through fluid passages “E1(FL)” and “E1(RR)”, respectively.

A node “I1” between fluid passages C1(FL) and E1(FL) is hydraulically connected to master cylinder M/C through fluid passage A1. A node “J1” between fluid passages C1(FL) and C1(RR) is hydraulically connected to fluid passage B1 through a fluid passage “G1”.

Shut-off valve S.OFF/V1, which is a normally open electromagnetic valve, is disposed in fluid passage A1 for selectively allowing or inhibiting fluid communication between master cylinder M/C and node I1.

Front left and rear right inlet valves IN/V(FL) and IN/V(RR) are normally closed linear electromagnetic valves disposed in fluid passages C1(FL) and C1(RR), respectively, for continuously regulating the hydraulic pressures supplied from hydraulic pump P1, and supplying the regulated hydraulic pressures to front left and rear right wheel cylinders W/C(FL) and W/C(RR). The construction that front left and rear right inlet valves IN/V(FL) and IN/V(RR) are normally closed linear electromagnetic valves, serves for preventing brake fluid from inversely flowing to hydraulic pump P1 from master cylinder M/C.

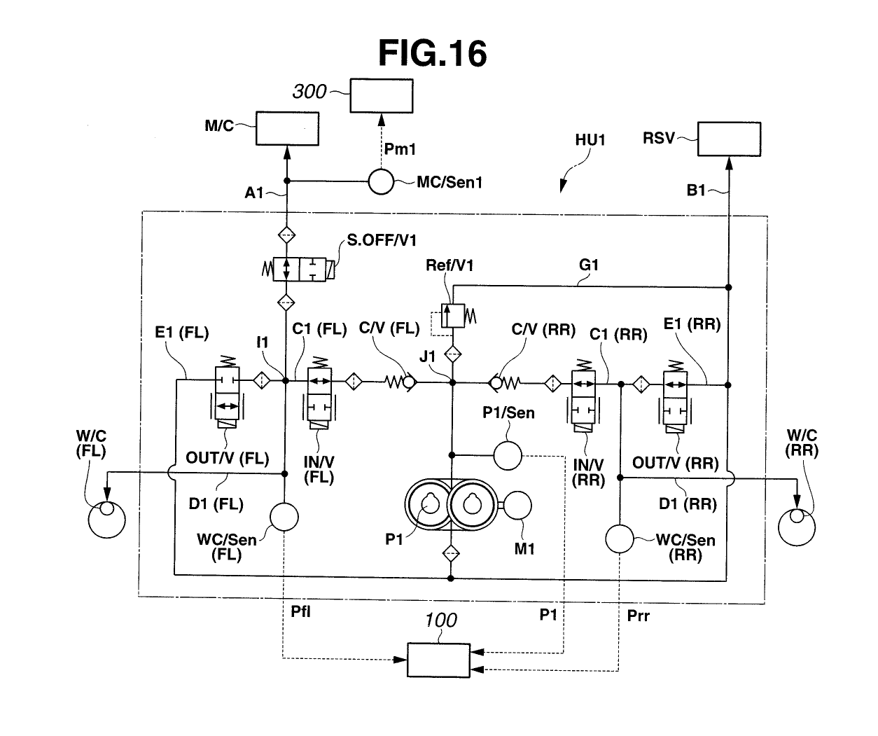

Front left and rear right inlet valves IN/V(FL) and IN/V(RR) may be normally open linear electromagnetic valves, for minimizing consumption of electric power when the brake-by-wire system is activated, as shown in FIG. 16. In such a case, check valves C/V(FL) and C/V(RR) are provided for preventing brake fluid from inversely flowing to hydraulic pump P1 from master cylinder M/C.

Front left and rear right outlet valves OUT/V(FL) and OUT/V(RR) are provided in fluid passages E1(FL) and E1(RR), respectively. Front left outlet valve OUT/V(FL) is a normally closed linear electromagnetic valve, while rear right outlet valve OUT/V(RR) is a normally open linear electromagnetic valve. Fluid passage G1 is provided with a relief valve “Ref/V1”.

First master cylinder pressure sensor MC/Sen1 is provided in fluid passage A1 between first hydraulic unit HU1 and master cylinder M/C, for outputting a data signal indicative of first measured master cylinder pressure Pm1 to main ECU 300. In first hydraulic unit HU1, front left and rear right wheel cylinder pressure sensors WC/Sen(FL) and WC/Sen(RR) are provided in fluid passages C1(FL) and C1(RR), respectively, for measuring the internal pressures of wheel cylinders W/C(FL) and W/C(RR), and outputting data signals indicative of measured front left and rear right wheel cylinder pressures Pfl and Prr, respectively, to first sub ECU 100. A first pump discharge pressure “P1/Sen” is provided on the discharge side of first hydraulic pump P1, for outputting a data signal indicative of measured first pump discharge pressure Pp1 to first sub ECU 100.

Fluid passages A1, B1, C1(FL), C1(RR), D1(FL), D1(RR), E1(FL), and E1(RR) thus serve as a fluid passage section hydraulically connected between a hydraulic pressure source and a wheel cylinder. Valves S.OFF/V1, IN/V(FL), IN/V(RR), OUT/V(FL), and OUT/V(RR) thus serve as a selector arranged to regulate fluid communication through the fluid passage section between the hydraulic pressure source and the wheel cylinder. Each of pump discharge pressure sensors P1/Sen and P2/Sen serves as a pressure sensor arranged to measure a quantity correlated to the hydraulic pressure outputted by the hydraulic pressure source. Each of wheel cylinder pressure sensors WC/Sen(FL), WC/Sen(FR), WC/Sen(RL) and WC/Sen(RR) serves as a pressure sensor arranged to measure a quantity correlated to an internal pressure of the wheel cylinder.

[Normal Braking Mode] When it is desired to increase the wheel cylinder pressures under normal operating conditions, then first sub ECU 100 closes shut-off valve S.OFF/V1, closes front left and rear right outlet valves OUT/V(FL) and OUT/V(RR), and drives first motor M1. Accordingly, first motor M1 drives first hydraulic pump P1 so as to supply a discharge pressure to fluid passages C1(FL) and C1(RR), and front left and rear right inlet valves IN/V(FL) and IN/V(RR) control the fluid pressures and supply them to front left and rear right wheel cylinders W/C(FL) and W/C(RR), so as to increase the wheel cylinder pressures.

When it is desired to reduce the wheel cylinder pressures under normal operating conditions, then first sub ECU 100 closes inlet valves IN/V(FL) and IN/V(RR), and opens outlet valves OUT/V(FL) and OUT/V(RR), for draining the brake fluid from front left and rear right wheel cylinders W/C(FL) and W/C(RR) to reservoir RSV, so as to reduce the wheel cylinder pressures.

When it is desired to hold constant the wheel cylinder pressures under normal operating conditions, then first sub ECU 100 closes all of front left and rear right inlet valves IN/V(FL) and IN/V(RR) and front left and rear right outlet valves OUT/V(FL) and OUT/V(RR) so as to hold constant the wheel cylinder pressures.

[Manual Braking Mode] When the brake control apparatus is operating in manual braking mode, for example, when the brake-by-wire system is failed, then shut-off valve S.OFF/V1 is opened, and front left and rear right inlet valves IN/V(FL) and IN/V(RR) are closed. On the other hand, front left outlet valve OUT/V(FL) is de-energized to be closed so that master cylinder pressure Pm is applied to front left wheel cylinder W/C(FL). Thus, master cylinder pressure Pm, which is increased by a driver's pedal depressing force, is applied to front left wheel cylinder W/C(FL), allowing manual braking.

It is alternatively considered that manual braking is applied to rear right wheel RR. In such a case, the load to depression of the driver is relatively large, because the wheel cylinder pressure of both of front left and rear right wheels FL and RR are implemented by the pedal depressing force. Accordingly, first hydraulic unit HU1 applies manual braking only to front left wheel FL, because front left wheel FL is subject to a larger load from a road, and thereby capable of generating a larger braking effort. On the other hand, rear right outlet valve OUT/V(RR) is implemented by a normally open valve so that when the brake-by-wire system is failed, rear right outlet valve OUT/V(RR) quickly drains the remaining hydraulic pressure of rear right wheel cylinder W/C(RR) so as to prevent rear right wheel RR from locking up.

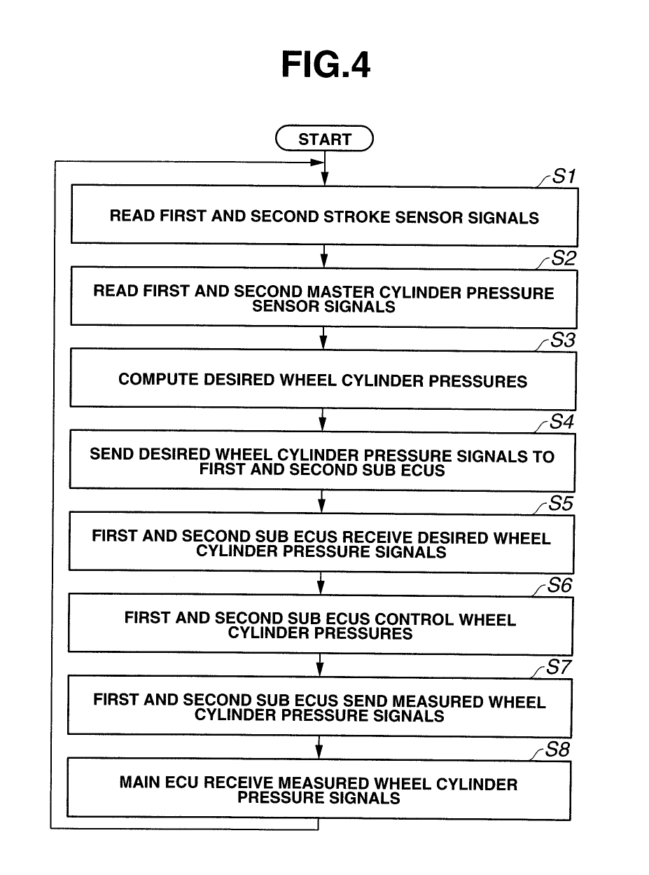

Second hydraulic unit HU2 has a similar circuit configuration as shown in FIG. 3, and performs a similar control as first hydraulic unit HU1. In second hydraulic unit HU2, front right outlet valve OUT/V(FR) is implemented by a normally closed valve, and rear left outlet valve OUT/V(RL) is implemented by a normally open valve, so that manual braking is applied only to front right wheel FR when the brake-by-wire system is failed.

[Process of Brake-By-Wire Control] FIG. 4 shows a control process of brake-by-wire control performed by main ECU 300 and first and second sub ECUs 100 and 200 of control section 1.

At Step S1, main ECU 300 reads first and second stroke signals S1 and S2, and then proceeds to Step S2.

At Step S2, main ECU 300 reads signals indicative of first and second master cylinder pressures Pm1 and Pm2, and then proceeds to Step S3.

At Step S3, first and second CPUs 310 and 320 of main ECU 300 compute desired wheel cylinder pressures P*fl to P*rr of first and second hydraulic units HU1 and HU2, and then proceeds to Step S4.

At Step S4, main ECU 300 sends signals indicative of desired wheel cylinder pressures P*fl to P*rr to first and second sub ECUs 100 and 200, and then proceeds to Step S5.

At Step S5, first and second sub ECUs 100 and 200 receive the signals of desired wheel cylinder pressures P*fl to P*rr, and then proceeds to Step S6.

At Step S6, first and second sub ECUs 100 and 200 operate first and second hydraulic units HU1 and HU2 to control actual wheel cylinder pressures Pfl to Prr, and then the proceeds to Step S7.

At Step S7, first and second sub ECUs 100 and 200 send signals indicative of measured wheel cylinder pressures Pfl to Prr to main ECU 300, and then proceeds to Step S8.

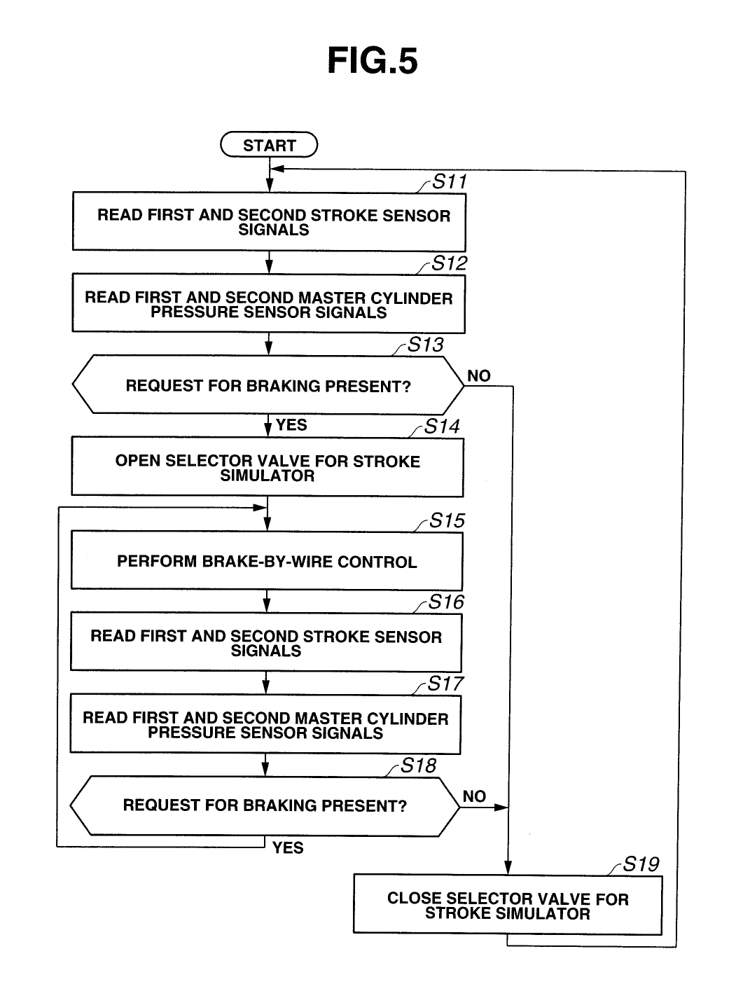

At Step S8, main ECU 300 receives the signals of measured wheel cylinder pressures Pfl to Prr, and then returns to Step S1.

[Process of Controlling Selector Valve for Stroke Simulator] FIG. 5 shows a control process of controlling the selector valve Can/V for stroke simulator S/Sim, which is performed by main ECU 300 of control section 1. Main ECU 300 selectively performs a brake-by-wire control of pressurizing the wheel cylinders by hydraulic pumps P1 and P2 while closing the selector valve Can/V, or allows a manual braking of providing a braking effort based on the master cylinder pressure while opening the selector valve Can/V.

At Step S11, main ECU 300 reads first and second stroke signals S1 and S2, and then proceeds to Step S12.

At Step S12, main ECU 300 reads signals indicative of first and second master cylinder pressures Pm1 and Pm2, and then proceeds to Step S13.

At Step S13, main ECU 300 judges on the basis of the read stroke signals S1 and S2 and first and second master cylinder pressures Pm1 and Pm2 whether or not a request for braking by driver is present. When the answer to Step S13 is affirmative (YES), then the process proceeds to Step S14. When the answer to Step S13 is negative (NO), then the process proceeds to Step S19.

At Step S14, main ECU 300 opens selector valve Can/V, and then proceeds to Step S15.

At Step S15, main ECU 300 performs the brake-by-wire control shown in FIG. 4, and then proceeds to Step S16.

At Step S16, main ECU 300 reads first and second stroke signals S1 and S2, and then proceeds to Step S17.

At Step S17, main ECU 300 reads signals indicative of first and second master cylinder pressures Pm1 and Pm2, and then proceeds to Step S18.

At Step S18, main ECU 300 judges on the basis of the read stroke signals S1 and S2 and first and second master cylinder pressures Pm1 and Pm2 whether or not a request for braking by driver is present. When the answer to Step S18 is YES, then the process proceeds to Step S15. When the answer to Step S18 is NO, then the process proceeds to Step S19.

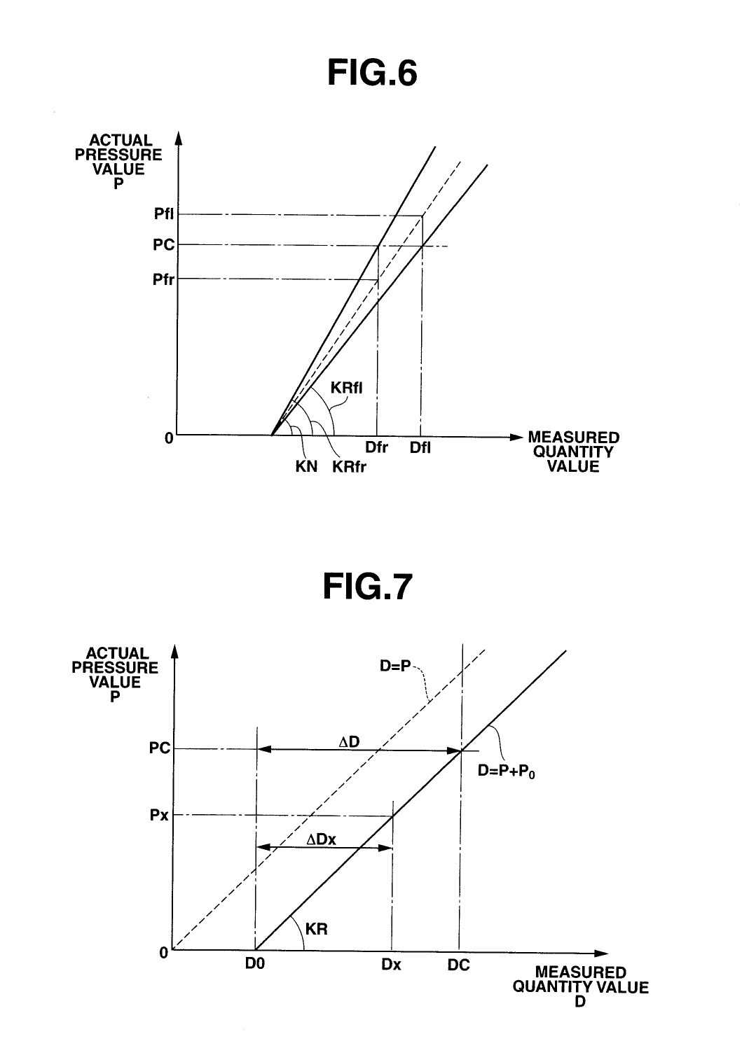

At Step S19, main ECU 300 closes selector valve Can/V, and then returns to Step S11.

[Accurate Determination of Hydraulic Pressure Values] Variation among hydraulic sensors causes a significant effect on braking performance of a brake-by-wire system adapted to all four wheels. In order to minimize such an effect, the brake control apparatus performs a process of calibration in production facilities before shipping, and a process of recalibration while the brake control apparatus is mounted on the vehicle.

<Computing of Pressure Coefficient> FIG. 6 shows a process of calibration for front left and right wheel cylinder pressure sensors WC/Sen(FL) and WC/Sen(FR). The vertical axis indicates an actual pressure value P. The horizontal axis indicates a measured quantity value D. Each sensor is provided with a linear line defining a relationship between P and D in FIG. 6. Quantities related to front left wheel cylinder pressure sensor WC/Sen(FL) are provided with a suffix “fl”, while quantities related to front right wheel cylinder pressure sensor WC/Sen(FR) are provided with a suffix “fr”. P is expressed by the following equations.

Pfl=KRfl·(Dfl−D0fl)

Pfr=KRfr·(Dfr−D0fr)

where D0 represents an initial value of D at P=0 (atmospheric pressure), KRfl represents a pressure coefficient of front left wheel cylinder pressure sensor WC/Sen(FL) which is a rate of change of Pfl with respect to Dfl, and KRfr represents a pressure coefficient of front left wheel cylinder pressure sensor WC/Sen(FL) which is a rate of change of Pfr with respect to Dfr.

In general, Dfl is different from Dfr with respect to identical actual pressure values, and KRfl is different from KRfr, due to variation between front left and right wheel cylinder pressure sensors WC/Sen(FL) and WC/Sen(FR), or specific errors of the sensors. Accordingly, the linear line defining the relationship between Pfl and Dfl is different from the liner line defining the relationship between Pfr and Dfr, as shown in FIG. 6.

When the brake system is controlled based on a common control target for front left and right wheels FL and FR under normal operating conditions, then front left and right wheel cylinder pressure sensors WC/Sen(FL) and WC/Sen(FR) are constantly subject to pressures identical to each other. Since the pressure coefficients are computed beforehand for calibration, the pressure values can be accurately computed even when front left and right wheel cylinder pressure sensors WC/Sen(FL) and WC/Sen(FR) show different measured quantity values.

When pressures of a reference pressure value PC are applied to front left and right wheel cylinders W/C(FL) and W/C(FR), and front left and right wheel cylinder pressure sensors WC/Sen(FL) and WC/Sen(FR) output different measured quantity values Dfl and Dfr, reference pressure value PC can be estimated or computed by multiplying the measured quantity values Dfl and Dfr by the pressure coefficients KRfl and KRfr, respectively.

For each of the hydraulic pressure sensors other than front left and right wheel cylinder pressure sensors WC/Sen(FL) and WC/Sen(FR), a pressure coefficient is computed beforehand. This allows to accurately compute a subject pressure value even when the sensors output different measured quantity values based on pressures of a single pressure value.

Reference pressure value PC is defined by determining suitable values of Pfl and Pfr, and computing an average of the values.

<First Calibrating Operation: Computing of Pressure Coefficients of Front Left and Right Wheel Cylinder Pressure Sensors> First, before shipping from production facilities, the master cylinder pressure Pm is set to a reference pressure value PC, and the pressure coefficients KRfl and KRfr are computed for front left and right wheel cylinder pressure sensors WC/Sen(FL) and WC/Sen(FR) which are arranged in fluid passages A1 and A2 which constitute a circuit for manual braking.

The computed pressure coefficients KRfl and KRfr are memorized or stored in control section 1. These values are used for computing actual pressure values P by multiplying measured quantity values Dfl and Dfr by the pressure coefficients KRfl and KRfr, respectively, when the brake control apparatus is operating on the vehicle.

For computing of the pressure coefficients KRfl and KRfr, first and second hydraulic units HU1 and HU2 are controlled as follows. In first and second hydraulic units HU1 and HU2, shut-off valves S.OFF/V1 and S.OFF/V2 are opened, and front left and right inlet valves IN/V(FL) and IN/V(FR) and front left and right outlet valves OUT/V(FL) and OUT/V(FR) are closed. This shuts off front left and right wheel cylinders W/C(FL) and W/C(FR) from first and second hydraulic pumps P1 and P2, so as to form a closed circuit where master cylinder M/C is connected to front left and right wheel cylinders W/C(FL) and W/C(FR) through fluid passages A1 and A2.

When master cylinder M/C is pressurized under the condition described above, then any different points in the closed circuit are subject to identical pressure values. At the time, values of the measured quantity are simultaneously obtained by front left and right wheel cylinder pressure sensors WC/Sen(FL) and WC/Sen(FR), and then pressure coefficients KRfl and KRfr are computed.

<Second Calibrating Operation: Computing of Pressure Coefficients of Rear Left and Right Wheel Cylinder Pressure Sensors and First and Second Pump Discharge Pressure Sensors> The second calibrating operation is to identify the pressure coefficients KRrl, KRrr, KRp1, and KRp2 for rear left and left wheel cylinder pressure sensors WC/Sen(RL) and WC/Sen(RR), and pump discharge pressure sensors P1/Sen and P2/Sen, for computing actual pressure values P by multiplying measured quantity values Drl, Drr, Dp1 and Dp2 by the pressure coefficients.

For computing of the pressure coefficients KRrl, KRrr, KRp1, and KRp2, first hydraulic unit HU1 is controlled as follows. Shut-off valve S.OFF/V1 is closed, front left and rear right inlet valves IN/V(FL) and IN/V(RR) are opened, front left and rear right outlet valves OUT/V(FL) and OUT/V(RR) are closed. This forms a closed circuit pressurized by first hydraulic pump P1 where front left and rear right wheel cylinders W/C(FL) and W/C(RR) are connected to first hydraulic pump P1 through fluid passages C1(FL) and C1(RR) and fluid passages D1(FL) and D1(RR).

When first hydraulic pump P1 is driven under the condition described above, then any different points in the closed circuit are subject to identical pressure values. At the time, values of the measured quantity are simultaneously obtained by rear right wheel cylinder pressure sensor WC/Sen(RR) and first pump discharge pressure sensor P1/Sen, and then pressure coefficients KRrr and KRp1 are computed with respect to front left wheel cylinder pressure sensor WC/Sen(FL).

Similar operations are performed for rear left wheel cylinder pressure sensor WC/Sen(RL) and second pump discharge pressure sensor P2/Sen in second hydraulic unit HU2.

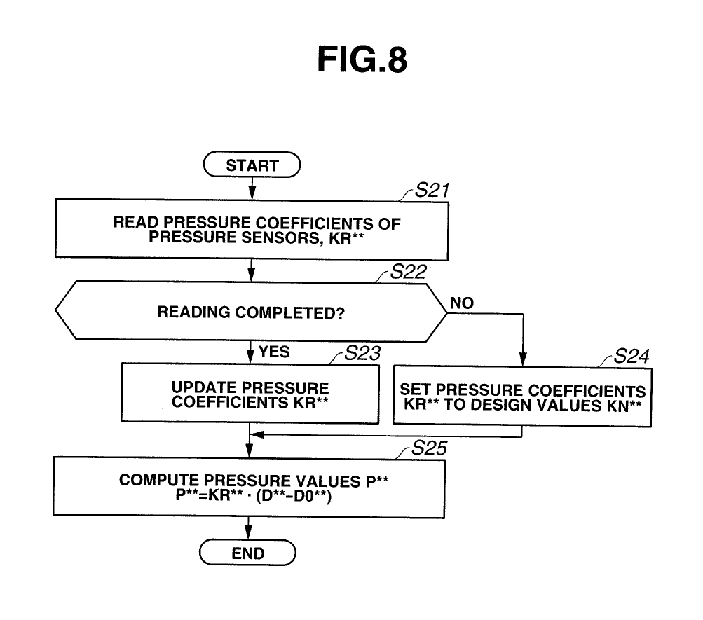

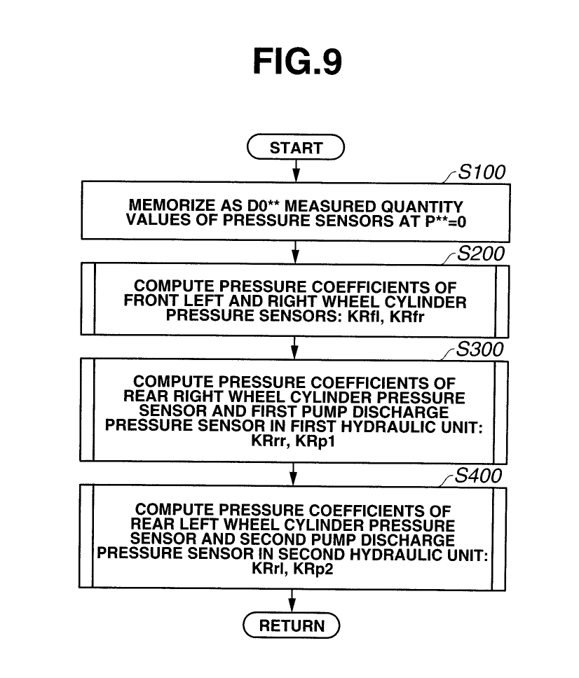

In this way, actual pressure values can be accurately determined, even when there is variation between the pressure sensors.

[Process of Computing of Hydraulic Pressures] FIG. 8 shows a process of computing hydraulic pressures. This process is performed in parallel to processes of calibration which are described in detail below with reference to FIGS. 9 to 11.

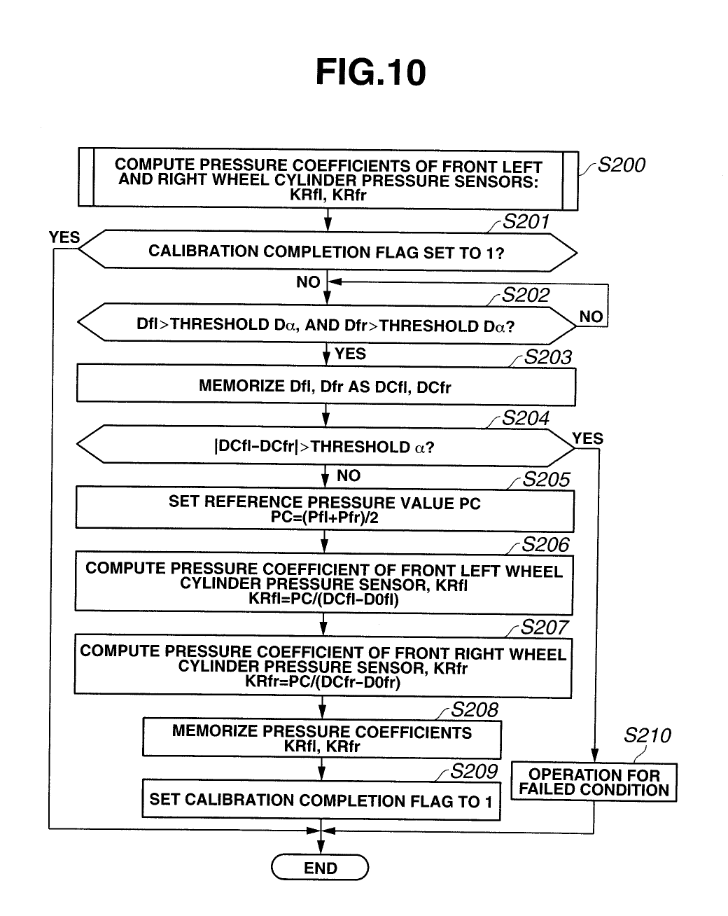

At Step S21, main ECU 300 reads the pressure coefficients KRfl, KRfr, KRrl, KRrr, KRp1, KRp2, KRm1, and KRm2 (henceforth collectively referred to as KR**) stored for wheel cylinder pressure sensors WC/Sen(FL), WC/Sen(FR), WC/Sen(RL) and WC/Sen(RR), pump discharge pressure sensors P1/Sen and P2/Sen, and first and second master cylinder pressure sensors MC/Sen1 and MC/Sen2, and then proceeds to Step S22. The pressure coefficients KR** are updated or computed through the parallel processes of FIGS. 9 and 10, as described in detail below.

At Step S22, main ECU 300 judges whether or not the reading operation of Step S21 is completed. When the answer to Step S22 is YES, then the process proceeds to Step S23. On the other hand, when the answer to Step S22 is NO, the process proceeds to Step S24.

At Step S23, main ECU 300 updates the pressure coefficients KR** by replacing the current values with the values read at Step S21, and then proceeds to Step S25.

At Step S24, main ECU 300 sets the pressure coefficients KR** to predetermined design pressure coefficient values KN**, and then proceeds to Step S25. Main ECU 300 memorizes the design pressure coefficient values KN** as a default value set of the pressure coefficients KR**.

At Step S25, main ECU 300 computes an actual pressure value P** using the following equations, and returns from this process.

P**=KR**·(D**−D0**)

[Process of Calibration of Hydraulic Pressure Sensors] <Main Process> FIG. 9 shows a main process of calibration of hydraulic pressure sensors.

At Step S100, main ECU 300 memorizes or stores the measured quantity values D0** when the hydraulic pressures are equal to zero (or the atmospheric pressure), and then proceeds to Step S200.

At Step S200, main ECU 300 computes the pressure coefficients KRfl and KRfr for front left and right wheel cylinder pressure sensors WC/Sen(FL) and WC/Sen(FR), and then proceeds to Step S300.

At Step S300, main ECU 300 computes the pressure coefficients KRrr and KRp1 for rear right wheel cylinder pressure sensor WC/Sen(RR) and first pump discharge pressure sensor P1/Sen which are arranged in first hydraulic unit HU1, and then proceeds to Step S400.

At Step S400, main ECU 300 computes the pressure coefficients KRrl and KRp2 for rear left wheel cylinder pressure sensor WC/Sen(RL) and second pump discharge pressure sensor P2/Sen which are arranged in second hydraulic unit HU2, and then returns from this process.

<First Calibrating Operation: Computing of Pressure Coefficients of Front Left and Right Wheel Cylinder Pressure Sensors> FIG. 10 shows a process of computing the pressure coefficients KRfl and KRfr for front left and right wheel cylinder pressure sensors WC/Sen(FL) and WC/Sen(FR).

At Step S201, main ECU 300 judges whether or not a flag referred to as calibration completion flag is set to 1. When the answer to Step S201 is YES, then the process returns from this process. On the other hand, when the answer to Step S201 is NO, then the process proceeds to Step S202.

At Step S202, main ECU 300 judges whether or not the measured quantity value Dfl is larger than a predetermined threshold value Dα, and the measured quantity value Dfr is larger than the threshold value Dα. When the answer to Step S202 is YES, then the process proceeds to Step S203. On the other hand, when the answer to Step S202 is NO, then main ECU 300 repeats the operation of Step S202. This is effective for preventing the main ECU 300 from performing the process of calibration when the measured quantity values Dfl and Dfr are small so that the level of errors such as bit errors is relatively high.

At Step S203, main ECU 300 memorizes or stores the current measured quantity values Dfl and Dfr as reference measured quantity values DCfl and DCfr, and then proceeds to Step 5204.

At Step S204, main ECU 300 judges whether or not the absolute value of a difference |DCfl−DCfr| is larger than a predetermined threshold value α. When the answer to Step S204 is YES, then the process proceeds to Step S210. On the other hand, when the answer to Step S204 is NO, then the process proceeds to Step S205.

At Step S205, main ECU 300 sets the reference pressure value PC to the average of measured front left and right wheel cylinder pressures Pfl and Prr which are computed in the process of FIG. 8, and then proceeds to Step S206.

At Step S206, main ECU 300 computes the pressure coefficient KRfl for front left wheel cylinder pressure sensor WC/Sen(FL) using the following equation, and then proceeds to Step S207.

KRfl=PC/(DCfl−D0fl)

At Step S207, main ECU 300 computes the pressure coefficient KRfr for front right wheel cylinder pressure sensor WC/Sen(FR) using the following equation, and then proceeds to Step S208.

KRfr=PC/(DCfr−D0fr)

At Step S208, main ECU 300 memorizes or stores the computed pressure coefficients KRfl and KRfr, and then proceeds to Step S209.

At Step S209, main ECU 300 sets the calibration completion flag to 1, and then returns from this process.

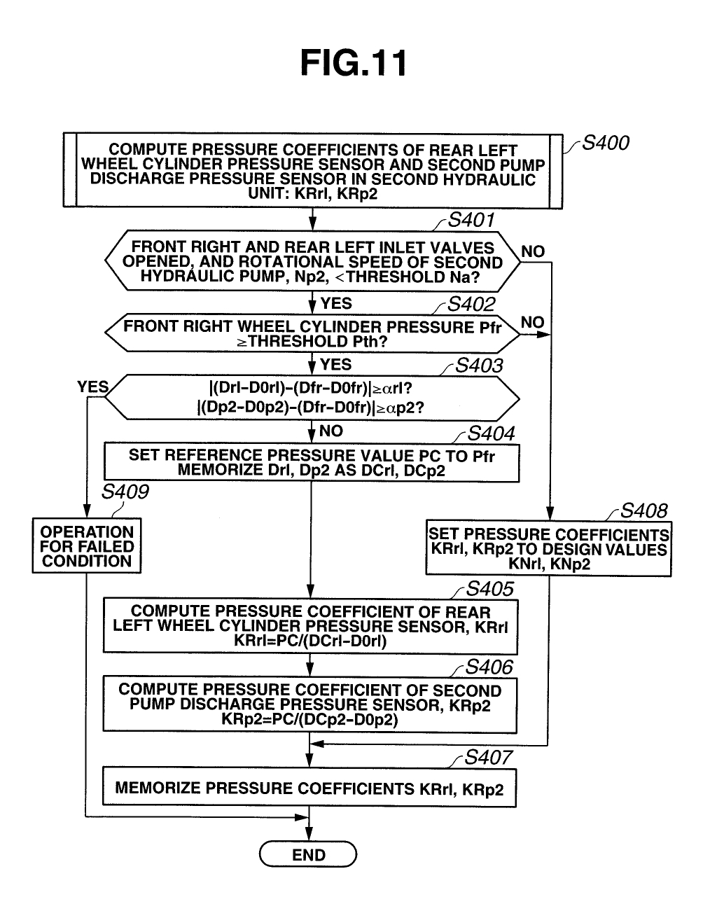

At Step S210, main ECU 300 performs an operation for failed condition, such as an operation of lightening a warning lamp, and then returns from this process.

<Second Calibrating Operation: Computing of Pressure Coefficients of Rear Left and Right Wheel Cylinder Pressure Sensors and First and Second Pump Discharge Pressure Sensors> FIG. 11 shows a process of calibration for rear left wheel cylinder pressure sensor WC/Sen(RL) and second pump discharge pressure sensor P2/Sen which are arranged in second hydraulic unit HU2. A similar process is performed for first hydraulic unit HU1.

At Step S401, main ECU 300 judges whether or not front right and rear left inlet valves IN/V(FR) and IN/V(RL) are opened, and a rotational speed Np2 of second hydraulic pump P2 is lower than a predetermined threshold value Na. When the answer to Step S401 is YES, then the process proceeds to Step S402. On the other hand, when the answer to Step S401 is NO, then the process proceeds to Step S408. The operation of Step S401 is performed to avoid situations in which when second hydraulic pump P2 is rotating at high speeds, flow resistances such as due to front right and rear left inlet valves IN/V(FR) and IN/V(RL) are large so that second measured pump discharge pressure Pp2 may differ from measured front right and rear left wheel cylinder pressures Pfr and Prl.

At Step S402, main ECU 300 judges whether or not measured front right wheel cylinder pressure Pfr, which is computed through the process of FIG. 8, is higher than a predetermined threshold value Pth. When the answer to Step S402 is YES, then the process proceeds to Step S403. On the other hand, when the answer to Step S402 is NO, then the process proceeds to Step S408.

At Step S403, main ECU 300 judges whether or not at least one of the following equations is satisfied.

|(Drl−D0rl)−(Dfr−D0fr)|≧αrl

|(Dp2−D0p2)−(Dfr−D0fr)|≧αp2

where αrl represents a predetermined threshold value for judging whether or not rear left wheel cylinder pressure sensor WC/Sen(RL) is abnormal, and αp2 represents a predetermined threshold value for judging whether or not second pump discharge pressure sensor P2/Sen is abnormal. When the answer to Step S403 is YES, then the process proceeds to Step S409. On the other hand, when the answer to Step S403 is NO, then the process proceeds to Step S404.

At Step S404, main ECU 300 sets the reference pressure value PC equal to the measured front right wheel cylinder pressure Pfr, and sets the reference measured quantity value DCrl to the measured quantity value Drl at the time of reference pressure value PC. Also, main ECU 300 sets the reference measured quantity value DCp2 to the measured quantity value Dp2 at the time of reference pressure value PC, and proceeds to Step S405.

At Step S405, main ECU 300 computes the pressure coefficient KRrl using the following equation, and then proceeds to Step S406.

KRrl=PC/(DCrl−D0rl)

At Step S406, main ECU 300 computes the pressure coefficient KRp2 using the following equation, and then proceeds to Step S407.

KRp2=PC/(DCp2−D0p2)

At Step S407, main ECU 300 memorizes or stores the pressure coefficients KRrl and KRp2, and then returns from this process. Main ECU 300 thus memorizes the pressure coefficients KR** as a parameter set defining a general relationship between the measured quantities.

At Step S408, main ECU 300 sets the pressure coefficients KRrl and KRp2 to the predetermined design pressure coefficient values KNrl and KNp2, respectively, and then proceeds to Step S407.

At Step S409, main ECU 300 performs an operation for failed condition, such as an operation of lightening a warning lamp, and then returns from this process.

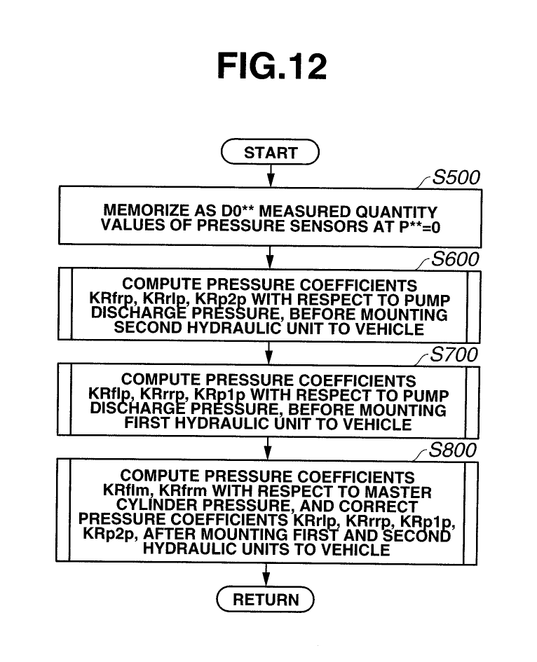

The following describes advantageous effects produced by features of the brake control apparatus according to the first embodiment.

<1> A brake control apparatus comprising: a hydraulic pressure source (P1; P2) arranged to output a hydraulic pressure (Pp1; Pp2); a wheel cylinder (W/C(FL), W/C(RR); W/C(FR), W/C(RL)) adapted to a wheel (FL, RR; FR, RL); a fluid passage section (A1, B1, C1(FL), C1(RR), D1(FL), D1(RR), E1(FL), E1(RR); A2, B2, C2(FR), C2(RL), D2(FR), D2(RL), E2(FR), E2(RL)) hydraulically connected between the hydraulic pressure source and the wheel cylinder; a selector (S.OFF/V1, IN/V(FL), IN/V(RR), OUT/V(FL), OUT/V(RR); S.OFF/V2, IN/V(FR), IN/V(RL), OUT/V(FR), OUT/V(RL)) arranged to regulate fluid communication through the fluid passage section between the hydraulic pressure source and the wheel cylinder; a first pressure sensor (P1/Sen; P2/Sen) arranged to measure a first quantity (Dp1; Dp2) correlated to the hydraulic pressure outputted by the hydraulic pressure source; a second pressure sensor (WC/Sen(FL), WC/Sen(RR); WC/Sen(FR), WC/Sen(RL)) arranged to measure a second quantity (Dfl, Drr; Dfr, Drl) correlated to an internal pressure of the wheel cylinder; and a controller (300) for controlling a braking force of the wheel by the wheel cylinder, the controller being configured to: allow the first pressure sensor to obtain a value of the first quantity, and allow the second pressure sensor to obtain a value of the second quantity, while allowing the selector to regulate fluid communication between the hydraulic pressure source and the wheel cylinder; and calibrate the first and second pressure sensors with respect to each other in accordance with the obtained values of the first and second quantities, is capable of more accurately calibrating the first and second pressure sensors based on measurement for at least a suitably separated part of the fluid passage section in which hydraulic pressure is assumed to be uniform.

<2> The brake control apparatus wherein the controller (300) is configured to determine that at least one of the first and second pressure sensors (P2/Sen, WC/Sen(FR); P2/Sen, WC/Sen(RL)) is failed, in response to determining that a difference between the obtained values of the first and second quantities is above a predetermined reference value (αp2; βp2), is capable of performing calibration with improved reliability.

<3> The brake control apparatus further comprising a master cylinder (M/C) hydraulically connected to the fluid passage section (A1, B1, C1(FL), C1(RR), D1(FL), D1(RR), E1(FL), E1(RR); A2, B2, C2(FR), C2(RL), D2(FR), D2(RL), E2(FR), E2(RL)), wherein: the hydraulic pressure source (P1; P2) is arranged to generate the hydraulic pressure independently of the master cylinder; the selector (S.OFF/V1, IN/V(FL), IN/V(RR), OUT/V(FL), OUT/V(RR); S.OFF/V2, IN/V(FR), IN/V(RL), OUT/V(FR), OUT/V(RL)) constitutes a hydraulic actuator (HU1; HU2) for regulating the internal pressure of the wheel cylinder (W/C(FL), W/C(RR); W/C(FR), W/C(RL)); and the controller (300) is configured to control the internal pressure of the wheel cylinder (W/C(FL), W/C(RR); W/C(FR), W/C(RL)) by the hydraulic pressure source and the hydraulic actuator, is capable of performing brake-by-wire control based on more accurate measurement with improved reliability.

<4> The brake control apparatus wherein: the fluid passage section (A1, B1, C1(FL), C1(RR), D1(FL), D1(RR), E1(FL), E1(RR); A2, B2, C2(FR), C2(RL), D2(FR), D2(RL), E2(FR), E2(RL)) includes: a first fluid passage (A1; A2) hydraulically connected between the master cylinder (M/C) and the wheel cylinder (W/C(FL), W/C(RR); W/C(FR), W/C(RL)); a second fluid passage (C1(FL), C1(RR); C2(FR), C2(RL)) hydraulically connected between the hydraulic pressure source (P1; P2) and the wheel cylinder; and a third fluid passage (E1(FL), E1(RR); E2(FR), E2(RL)) hydraulically connected between the wheel cylinder and a reservoir (RSV); the selector (S.OFF/V1, IN/V(FL), IN/V(RR), OUT/V(FL), OUT/V(RR); S.OFF/V2, IN/V(FR), IN/V(RL), OUT/V(FR), OUT/V(RL)) includes: a shut-off valve (S.OFF/V1; S.OFF/V2) arranged in the first fluid passage; an inlet valve (IN/V(FL), IN/V(RR); IN/V(FR), IN/V(RL)) arranged in the second fluid passage; and an outlet valve (OUT/V(FL), OUT/V(RR); OUT/V(FR), OUT/V(RL)) arranged in the third fluid passage; the first pressure sensor (P1/Sen; P2/Sen) is arranged in the second fluid passage; and the second pressure sensor (WC/Sen(FL), WC/Sen(RR); WC/Sen(FR), WC/Sen(RL)) is arranged at the wheel cylinder, is capable of providing a first closed circuit in which the master cylinder is hydraulically connected to the wheel cylinder and hydraulic pressure is assumed to be uniform, by opening the shut-off valve and closing the inlet valve and the outlet valve, capable of providing a second closed circuit in which the hydraulic pressure source is hydraulically connected to the wheel cylinder and hydraulic pressure is assumed to be uniform, by opening the inlet valve and closing the shut-off valve and the outlet valve, and capable of obtaining a measured quantity value related to the hydraulic pressure in the first closed circuit which is supplied by the master cylinder, and a measured quantity value related to the hydraulic pressure in the second closed circuit which is supplied by the hydraulic pressure source, independently of each other, and more accurately calibrating the pressure sensors by comparing the thus obtained measured quantity values.

<5> The brake control apparatus wherein the hydraulic actuator (HU1; HU2) includes a first hydraulic actuator (HU1) and a second hydraulic actuator (HU2), is capable of producing a braking force by one of the first and second hydraulic actuators, even when the other hydraulic actuator is failed.

<6> The brake control apparatus wherein: the hydraulic pressure source (P1; P2) includes a first hydraulic pressure source (P1) and a second hydraulic pressure source (P2); the first hydraulic actuator (HU1) includes the first hydraulic pressure source (P1); and the second hydraulic actuator (HU2) includes the second hydraulic pressure source (P2), is capable of performing brake-by-wire control with improved reliability, because the redundant hydraulic pressure sources serve for a fail-safe function.

<7> The brake control apparatus wherein: the fluid passage section (A1, B1, C1(FL), C1(RR), D1(FL), D1(RR), E1(FL), E1(RR); A2, B2, C2(FR), C2(RL), D2(FR), D2(RL), E2(FR), E2(RL)) includes: a first fluid passage (A1) hydraulically connecting the first hydraulic actuator (HU1) to the master cylinder (M/C); and a second fluid passage (A2) hydraulically connecting the second hydraulic actuator (HU2) to the master cylinder (M/C); the master cylinder supplies the first hydraulic actuator with a first hydraulic pressure (Pm1) through the first fluid passage, and supplies the second hydraulic actuator with a second hydraulic pressure (Pm2) through the second fluid passage; and the first hydraulic pressure is equal to the second hydraulic pressure, is capable of calibrating the pressure sensors provided in the first and second hydraulic actuators with respect to the master cylinder pressure.

<8> The brake control apparatus wherein: the first hydraulic actuator (HU1) is arranged to regulate internal pressures (Pfl, Prr) of wheel cylinders (W/C(FL), W/C(RR)) adapted to front left and rear right wheels (FL, RR); and the second hydraulic actuator (HU2) is arranged to regulate internal pressures (Pfr, Prl) of wheel cylinders (W/C(FR), W/C(RL)) adapted to front right and rear left wheels (FR, RL), is capable of distributing braking effort, 2 part to the front wheels and 1 part to the rear wheels, with the redundant hydraulic actuators which are identical to each other and in each of which the valve openings for the front and rear wheel cylinders are suitably adjusted.

<9> The brake control apparatus wherein the hydraulic pressure source (P1; P2) is a hydraulic pump, is capable of pressurizing the wheel cylinder directly by the hydraulic pump with no accumulator, which is advantageous for forming the brake control apparatus compact and preventing a possibility that a gas in such an accumulator leaks into a fluid passage under a failed condition.

<10> The brake control apparatus wherein the controller (300) is configured to suspend the calibration of the first and second pressure sensors, in response to determining that a quantity of state (Np2) of discharge of the hydraulic pressure source (P1; P2) is above a predetermined reference value (Na), is capable of more accurately calibrating the pressure sensors, while avoiding situations in which when the hydraulic pressure source is rotating at high speeds, flow resistances are large so that measured pump discharge pressure may differ from the measured wheel cylinder pressure.

<11> The brake control apparatus wherein the quantity of state of discharge of the hydraulic pressure source (P1; P2) is a rotational speed (Np2) of the hydraulic pressure source (P1; P2), is capable of easily determining that the quantity of state (Np2) of discharge of the hydraulic pressure source (P1; P2) is above a predetermined reference value (Na).

<12> The brake control apparatus wherein the controller (300) is configured to memorize a parameter set (KR**) defining a general relationship between the first and second quantities, is capable of allowing the parameter set to be easily accessed, whenever and however the pressure sensors are calibrated, for example, in cases where the hydraulic actuator is mounted to the vehicle after the pressure sensors are calibrated.

<13> The brake control apparatus wherein the controller (300) is configured to memorize a default value set (KN**) of the parameter set (KR**), is capable of continuing to operate based on the default value set, even when failing to read a corrected value set of the parameter set.

<14> A process of operating a brake control apparatus after mounting a hydraulic actuator (HU1; HU2) to a vehicle, the brake control apparatus including: a master cylinder (M/C); a first wheel cylinder (W/C(FL); W/C(FR)) adapted to a first wheel (FL; FR) of the vehicle; a second wheel cylinder (W/C(RR); W/C(RL)) adapted to a second wheel (FL, RR; FR, RL) of the vehicle; a hydraulic pump (P1; P2) arranged to output a hydraulic pressure (Pp1; Pp2) independently of the master cylinder; the hydraulic actuator (HU1; HU2) including: a first fluid passage (A1; A2) hydraulically connected between the master cylinder and the first wheel cylinder; a second fluid passage (C1(FL); C2(FR)) hydraulically connected between the hydraulic pump and the first wheel cylinder; a third fluid passage (C1(RR); C2(RL)) hydraulically connected between the hydraulic pump and the second wheel cylinder; a fourth fluid passage (E1(FL); E2(FR)) hydraulically connected between the first wheel cylinder and a reservoir (RSV); a fifth fluid passage (E1(RR); E2(RL)) hydraulically connected between the second wheel cylinder and the reservoir; a shut-off valve (S.OFF/V1; S.OFF/V2) arranged in the first fluid passage; a first inlet valve (IN/V(FL); IN/V(FR)) arranged in the second fluid passage; a second inlet valve (IN/V(RR); IN/V(RL)) arranged in the third fluid passage; a first outlet valve (OUT/V(FL); OUT/V(FR)) arranged in the fourth fluid passage; and a second outlet valve (OUT/V(RR); OUT/V(RL)) arranged in the fifth fluid passage; a first pressure sensor (WC/Sen(FL); WC/Sen(FR)) arranged to measure a first quantity (Dfl; Dfr) correlated to an internal pressure of the first wheel cylinder; a second pressure sensor (WC/Sen(RR); WC/Sen(RL)) arranged to measure a second quantity (Drr; Drl) correlated to an internal pressure of the second wheel cylinder; and a controller (300) configured to control the internal pressures of the first and second wheel cylinders by the hydraulic pump and the hydraulic actuator so as to control braking forces of the first and second wheels, the process comprising: establishing a first condition by opening the shut-off valve, closing the first and second inlet valves, closing the first and second outlet valves, and allowing the master cylinder to be pressurized, so as to generate a hydraulic pressure in the first fluid passage; calibrating the first pressure sensor under the first condition; establishing a second condition by closing the shut-off valve, opening the first and second inlet valves, closing the first and second outlet valves, and driving the hydraulic pump, so as to generate a hydraulic pressure in the second and third fluid passages; allowing the second pressure sensor to obtain a value of the second quantity under the second condition; and calibrating the second pressure sensor with respect to the first pressure sensor in accordance with the obtained value of the second quantity, is capable of calibrating the pressure sensors provided in the first and second hydraulic actuators with respect to the master cylinder pressure.

[Second Embodiment] The following describes a brake control apparatus according to a second embodiment of the present invention with reference to FIGS. 12 to 14. This brake control apparatus according to the second embodiment is constructed based on the brake control apparatus according to the first embodiment. Although the brake control apparatus according to the first embodiment computes the pressure coefficients KR** after first and second hydraulic units HU1 and HU2 are mounted to the vehicle, the brake control apparatus according to the second embodiment computes the pressure coefficients KR** before first and second hydraulic units HU1 and HU2 are mounted to the vehicle.

[Computing of Pressure Coefficient] <Third Calibrating Operation Before Mounting Hydraulic Units> First, a hydraulic pressure Pp is generated in fluid passages C1(FL), C1(RR), C2(FR) and C2(RL). The pressure coefficients with respect to the pressure Pp for wheel cylinder pressure sensors WC/Sen(FL), WC/Sen(FR), WC/Sen(RL) and WC/Sen(RR), and pump discharge pressure sensors P1/Sen and P2/Sen, are computed as KR**p.

For the computing, before first and second hydraulic units HU1 and HU2 are mounted to the vehicle so that first and second hydraulic units HU1 and HU2 are connected to master cylinder M/C, inlet valves IN/V(FL), IN/V(FR), IN/V(RL) and IN/V(RR) are opened, shut-off valves S.OFF/V1 and S.OFF/V2, and outlet valves OUT/V(FL), OUT/V(FR), OUT/V(RL) and OUT/V(RR) are closed. Under this condition, first and second hydraulic pumps P1 and P2 are driven to pressurize the fluid passages C1(FL), C1(RR), C2(FR) and C2(RL).

On the assumption that the pressure Pp is uniform in the fluid passages C1(FL), C1(RR), C2(FR) and C2(RL), the measured quantity values D**p are obtained by the wheel cylinder pressure sensors WC/Sen(FL), WC/Sen(FR), WC/Sen(RL) and WC/Sen(RR), and then the pressure coefficients KR**p are computed.

The reference pressure value PC for first hydraulic unit HU1, which is used for computing the pressure coefficient KR**p, is set to the average of the measured front left and rear right wheel cylinder pressures Pfl and Prr, and the first measured pump discharge pressure Pp1, using the following equation.

PC(HU1)=(Pfl+Prl+Pp1)/3

Similarly, the reference pressure value PC for second hydraulic unit HU2 is set to the average of the measured front right and rear left wheel cylinder pressures Pfr and Prl, and the second measured pump discharge pressure Pp2, using the following equation.

PC(HU2)=(Pfr+Prl+Pp2)/3

The third calibrating operation uses the measured wheel cylinder pressures Pfl, Pfr, Prl and Prr and first and second measured pump discharge pressures Pp1 and Pp2 that are computed in the process of FIG. 8. The process of FIGS. 12 to 14 are performed in parallel to the process of FIG. 8.

<Fourth Calibrating Operation After Mounting Hydraulic Units> After the third calibrating operation, first and second hydraulic units HU1 and HU2 are mounted to the vehicle so that master cylinder M/C is connected to first and second hydraulic units HU1 and HU2. Then, the pressure coefficients for front left and right wheel cylinder pressure sensors WC/Sen(FL) and WC/Sen(FR) in fluid passages A1 and A2 are recomputed as KRflm and KRfrm with respect to the master cylinder pressure Pm.

For the computing, shut-off valves S.OFF/V1 and S.OFF/V2 are opened, inlet valves IN/V(FL), IN/V(FR), IN/V(RL) and IN/V(RR) and outlet valves OUT/V(FL), OUT/V(FR), OUT/V(RL) and OUT/V(RR) are closed. Under this condition, master cylinder M/C is pressurized to generate hydraulic pressures in fluid passages A1 and A2, and then the measured quantity values Dfl and Dfr are obtained by front left and right wheel cylinder pressure sensors WC/Sen(FL) and WC/Sen(FR), and the pressure coefficients KRflm and KRfrm for front left and right wheel cylinder pressure sensors WC/Sen(FL) and WC/Sen(FR) are recomputed with respect to the master cylinder pressure Pm.

[Recalibration of Hydraulic Pressure Sensors] The pressure coefficients KR**p, which are computed through the third calibrating operation before first and second hydraulic units HU1 and HU2 are mounted, are modified with respect to the pressure coefficients KRflm and KRfrm, which are computed through the fourth calibrating operation. The pressure coefficients KR**p are adjusted as KR** to conform to the pressure coefficients KRflm and KRfrm which are computed with respect to master cylinder pressure Pm. The pressure coefficients KR** are thus computed accurately.

<Main Process> FIG. 12 shows a main process of calibration of hydraulic pressure sensors.

At Step S500, main ECU 300 memorizes or stores the measured quantity value D0** when the hydraulic pressures are equal to zero (or the atmospheric pressure), and then proceeds to Step S600.

At Step S600, main ECU 300 computes the pressure coefficients KRfrp, KRrlp and KRp2p with respect to the pump discharge pressure before second hydraulic unit HU2 is mounted, and then proceeds to Step S700.

At Step S700, main ECU 300 computes the pressure coefficients KRflp, KRrrp and KRp1p with respect to the pump discharge pressure before first hydraulic unit HU1 is mounted, and then proceeds to Step S800.

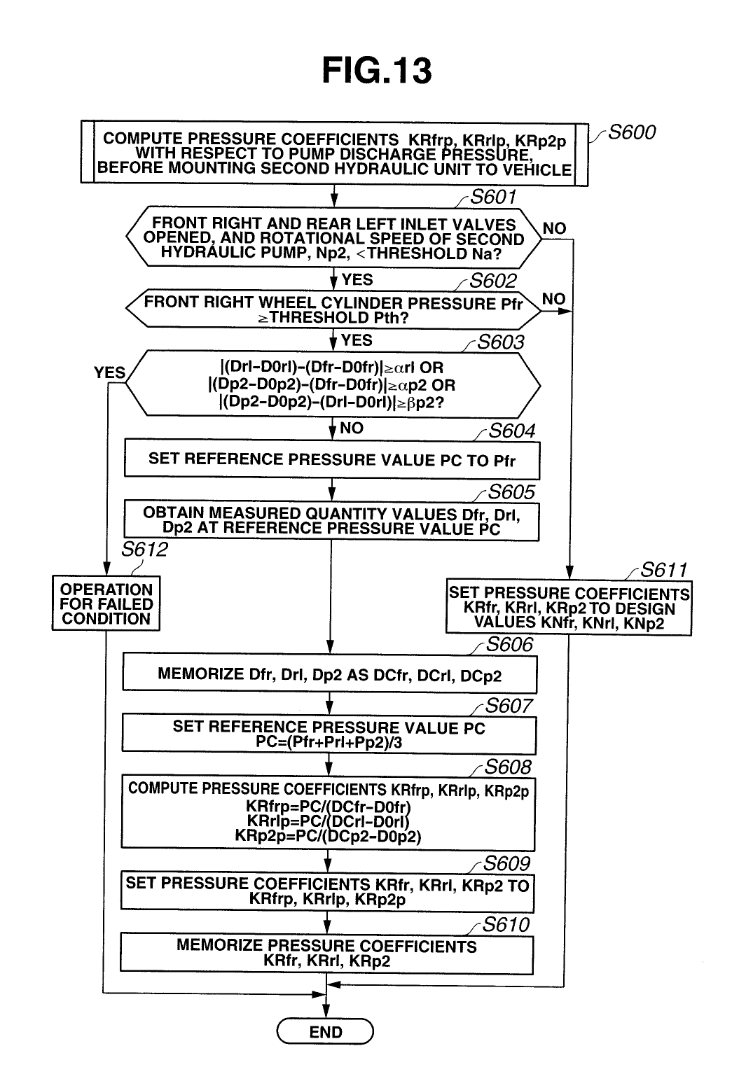

At Step S800, main ECU 300 computes the pressure coefficients KRflm and KRfrm with respect to master cylinder pressure Pm after first and second hydraulic units HU1 and HU2 are mounted, and corrects the pressure coefficients KRrlp, KRrrp, KRp1p and KRp2p in terms of KRflm and KRfrm, and then returns from this process.

<Third Calibrating Operation: Computing of Pressure Coefficient Before Mounding> FIG. 13 shows a process of computing pressure coefficients before mounting for second hydraulic unit HU2. A similar process is performed for first hydraulic unit HU1.

At Step S601, main ECU 300 judges whether or not front right and rear left inlet valves IN/V(FR) and IN/V(RL) are opened, and a rotational speed Np2 of second hydraulic pump P2 is lower than a predetermined threshold value Na. When the answer to Step S601 is YES, then the process proceeds to Step S602. On the other hand, when the answer to Step S601 is NO, then the process proceeds to Step S611.

At Step S602, main ECU 300 judges whether or not measured front right wheel cylinder pressure Pfr, which is computed through the process of FIG. 8, is higher than a predetermined threshold value Pth. When the answer to Step S602 is YES, then the process proceeds to Step S603. On the other hand, when the answer to Step S602 is NO, then the process proceeds to Step S611.

At Step S603, main ECU 300 judges whether or not at least one of the following equations is satisfied.

|(Drl−D0rl)−(Dfr−D0fr)|≧αrl

|(Dp2−D0p2)−(Dfr−D0fr)|≧αp2

|(Dp2−D0p2)−(Drl−D0rl)−≧βp2

where αrl, αp2 and βp2 represent predetermined threshold values for judging whether or not at least one of front right wheel cylinder pressure sensor WC/Sen(FR), rear left wheel cylinder pressure sensor WC/Sen(RL), and second pump discharge pressure sensor P2/Sen is abnormal. When the answer to Step S603 is YES, then the process proceeds to Step S612. On the other hand, when the answer to Step S603 is NO, then the process proceeds to Step S604.

At Step S604, main ECU 300 sets the reference pressure value PC equal to the measured front right wheel cylinder pressure Pfr, and then proceeds to Step S605.

At Step S605, main ECU 300 obtains the measured quantity values Dfr, Drl and Dp2 by front right wheel cylinder pressure sensor WC/Sen(FR), rear left wheel cylinder pressure sensor WC/Sen(RL), and second pump discharge pressure sensor P2/Sen, at the time of reference pressure value PC.

At Step S606, main ECU 300 sets the reference measured quantity values DCfr and DCrl to the measured quantity values Dfr and Drl obtained at Step S605. Also, main ECU 300 sets the reference measured quantity value DCp2 to the measured quantity value Dp2 obtained at Step S605, and proceeds to Step S607.

At Step S607, main ECU 300 sets or updates the reference pressure value PC to the average of the measured front right wheel cylinder pressure Pfr, measured rear left wheel cylinder pressure Prl and second measured pump discharge pressure Pp2, using the following equation.

PC=(Pfr+Prl+Pp2)/3

At Step S608, main ECU 300 computes the pressure coefficient KRfrp, KRrlp, and KRp2p with respect to the pump discharge pressure, using the following equations, and then proceeds to Step S609.

KRfrp=PC/(DCfr−D0fr)

KRrlp=PC/(DCrl−D0rl)

KRp2p=PC/(DCp2−D0p2)

At Step S609, main ECU 300 sets the pressure coefficients KR** to the computed pressure coefficients KR**p, and then proceeds to Step S610.

At Step S610, main ECU 300 memorizes or stores the pressure coefficients KR**, and then returns from this process.

At Step S611, main ECU 300 sets the pressure coefficient KRfrp, KRrlp, and KRp2p to design pressure coefficient values KNfr, KNrl and KNp2.

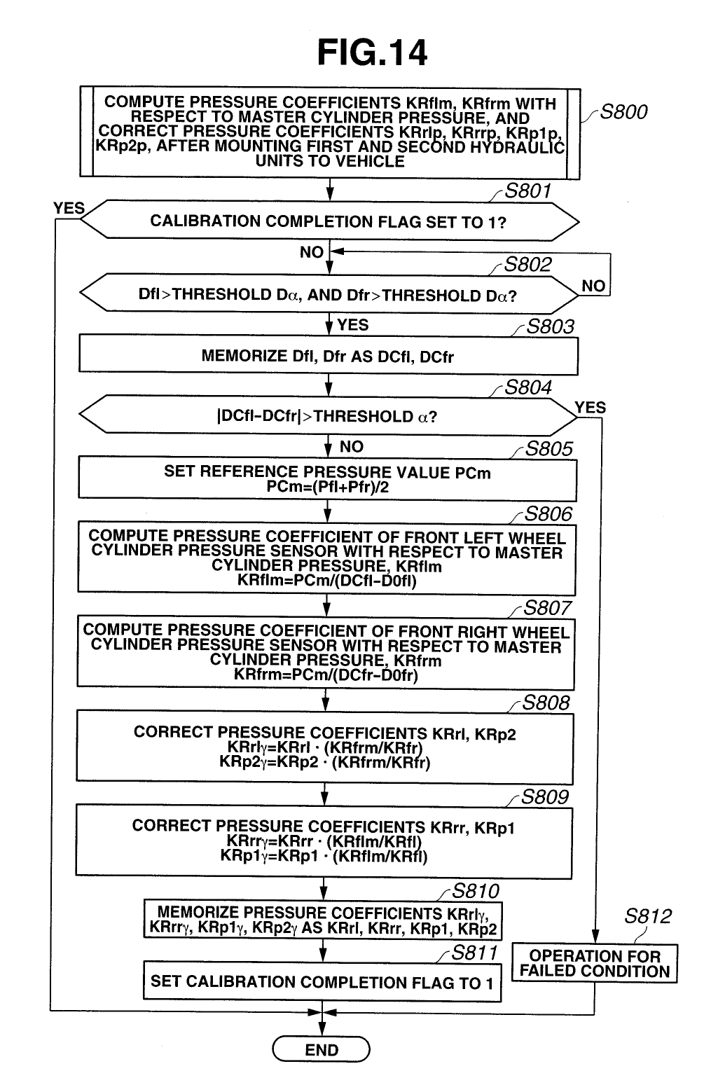

At Step S612, main ECU 300 performs an operation for failed condition, such as an operation of lightening a warning lamp, and then returns from this process.

[Fourth Calibrating Operation: Recalibration of Hydraulic Pressure Sensors After Mounting to Vehicle] FIG. 14 shows a process of recalibration of hydraulic pressure sensors after mounting to vehicle.

At Step S801, main ECU 300 judges whether or not a flag referred to as calibration completion flag is set to 1. When the answer to Step S801 is YES, then the process returns from this process. On the other hand, when the answer to Step S801 is NO, then the process proceeds to Step S802.

At Step S802, main ECU 300 judges whether or not the measured quantity value Dfl is larger than a predetermined threshold value Dα, and the measured quantity value Dfr is larger than the threshold value Dα. When the answer to Step S802 is YES, then the process proceeds to Step S803. On the other hand, when the answer to Step S802 is NO, then main ECU 300 repeats the operation of Step S802. This is effective for preventing the main ECU 300 from performing the process of calibration when the measured quantity values Dfl and Dfr are small so that the level of errors such as bit errors is relatively high.

At Step S803, main ECU 300 memorizes or stores the current measured quantity values Dfl and Dfr as reference measured quantity values DCfl and DCfr, and then proceeds to Step S804.

At Step S804, main ECU 300 judges whether or not the absolute value of a difference |DCfl−DCfr| is larger than a predetermined threshold value α. When the answer to Step S804 is YES, then the process proceeds to Step S812. On the other hand, when the answer to Step S804 is NO, then the process proceeds to Step S805.

At Step S805, main ECU 300 sets a reference pressure value PCm to the average of measured front left and right wheel cylinder pressures Pfl and Prr which are computed in the process of FIG. 8, and then proceeds to Step S806.

At Step S806, main ECU 300 computes the pressure coefficient KRflm for front left wheel cylinder pressure sensor WC/Sen(FL) using the following equation, and then proceeds to Step S807.

KRflm=PCm/(DCfl−D0fl)

At Step S807, main ECU 300 computes the pressure coefficient KRfrm for front right wheel cylinder pressure sensor WC/Sen(FR) using the following equation, and then proceeds to Step S808.

KRfrm=PCm/(DCfr−D0fr)

At Step S808, main ECU 300 computes corrected pressure coefficients KRrlγ and KRp2γ for rear left wheel cylinder pressure sensor WC/Sen(RL) and second pump discharge pressure sensor P2/Sen in second hydraulic unit HU2, using the following equations, and then proceeds to Step S809.

KRrlγ=KRrl·KRfrm/KRfr

KRp2γ=KRp2·KRfrm/KRfr

At Step S809, main ECU 300 computes corrected pressure coefficients KRrry and KRp1γ for rear right wheel cylinder pressure sensor WC/Sen(RR) and first pump discharge pressure sensor P1/Sen in first hydraulic unit HU1, using the following equations, and then proceeds to Step S810.

KRrry=KRrr·KRflm/KRfl

KPp1γ=KRp1·KRflm/KRfl

At Step S810, main ECU 300 memorizes or stores the computed pressure coefficients KR**γ as the pressure coefficients KR**, and then proceeds to Step S811.

At Step S811, main ECU 300 sets the calibration completion flag to 1, and then returns from this process.

At Step S812, main ECU 300 performs an operation for failed condition, such as an operation of lightening a warning lamp, and then returns from this process.

The following describes advantageous effects produced by features of the brake control apparatus according to the second embodiment.

<1> A process of operating a brake control apparatus, the brake control apparatus including: a master cylinder (M/C); a first wheel cylinder (W/C(FL); W/C(FR)) adapted to a first wheel (FL; FR) of a vehicle; a second wheel cylinder (W/C(RR); W/C(RL)) adapted to a second wheel (FL, RR; FR, RL) of the vehicle; a hydraulic pump (P1; P2) arranged to output a hydraulic pressure (Pp1; Pp2) independently of the master cylinder; a hydraulic actuator (HU1; HU2) including: a first fluid passage (A1; A2) hydraulically connected between the master cylinder and the first wheel cylinder; a second fluid passage (C1(FL); C2(FR)) hydraulically connected between the hydraulic pump and the first wheel cylinder; a third fluid passage (C1(RR); C2(RL)) hydraulically connected between the hydraulic pump and the second wheel cylinder; a fourth fluid passage (E1(FL); E2(FR)) hydraulically connected between the first wheel cylinder and a reservoir (RSV); a fifth fluid passage (E1(RR); E2(RL)) hydraulically connected between the second wheel cylinder and the reservoir; a shut-off valve (S.OFF/V1; S.OFF/V2) arranged in the first fluid passage; a first inlet valve (IN/V(FL); IN/V(FR)) arranged in the second fluid passage; a second inlet valve (IN/V(RR); IN/V(RL)) arranged in the third fluid passage; a first outlet valve (OUT/V(FL); OUT/V(FR)) arranged in the fourth fluid passage; and a second outlet valve (OUT/V(RR); OUT/V(RL)) arranged in the fifth fluid passage; a first pressure sensor (WC/Sen(FL); WC/Sen(FR)) arranged to measure a first quantity (Dfl; Dfr) correlated to an internal pressure of the first wheel cylinder; a second pressure sensor (WC/Sen(RR); WC/Sen(RL)) arranged to measure a second quantity (Drr; Drl) correlated to an internal pressure of the second wheel cylinder; and a controller (300) configured to control the internal pressures of the first and second wheel cylinders by the hydraulic pump and the hydraulic actuator so as to control braking forces of the first and second wheels, the process comprising: establishing a first condition by closing the shut-off valve, opening the first and second inlet valves, closing the first and second outlet valves, and driving the hydraulic pump, so as to generate a hydraulic pressure in the second and third fluid passages, before mounting the hydraulic actuator (HU1; HU2) to the vehicle; allowing the first pressure sensor to obtain a value of the first quantity under the first condition, and allowing the second pressure sensor to obtain a value of the second quantity under the first condition; calibrating the first and second pressure sensors with respect to each other in accordance with the obtained values of the first and second quantities; establishing a second condition by opening the shut-off valve, closing the first and second inlet valves, closing the first and second outlet valves, and allowing the first fluid passage to be pressurized; allowing the first pressure sensor to obtain a second value of the first quantity under the second condition; and recalibrating the first and second pressure sensors in accordance with the second value of the first quantity, is capable of improving the efficiency of a process of inspection at production facilities or others before mounting the hydraulic actuator to the vehicle, because the calibration (computing of KR**) can be performed in parallel to other operations of inspection.

<Modifications> The brake control apparatus according to the first and second embodiments may be modified as follows.

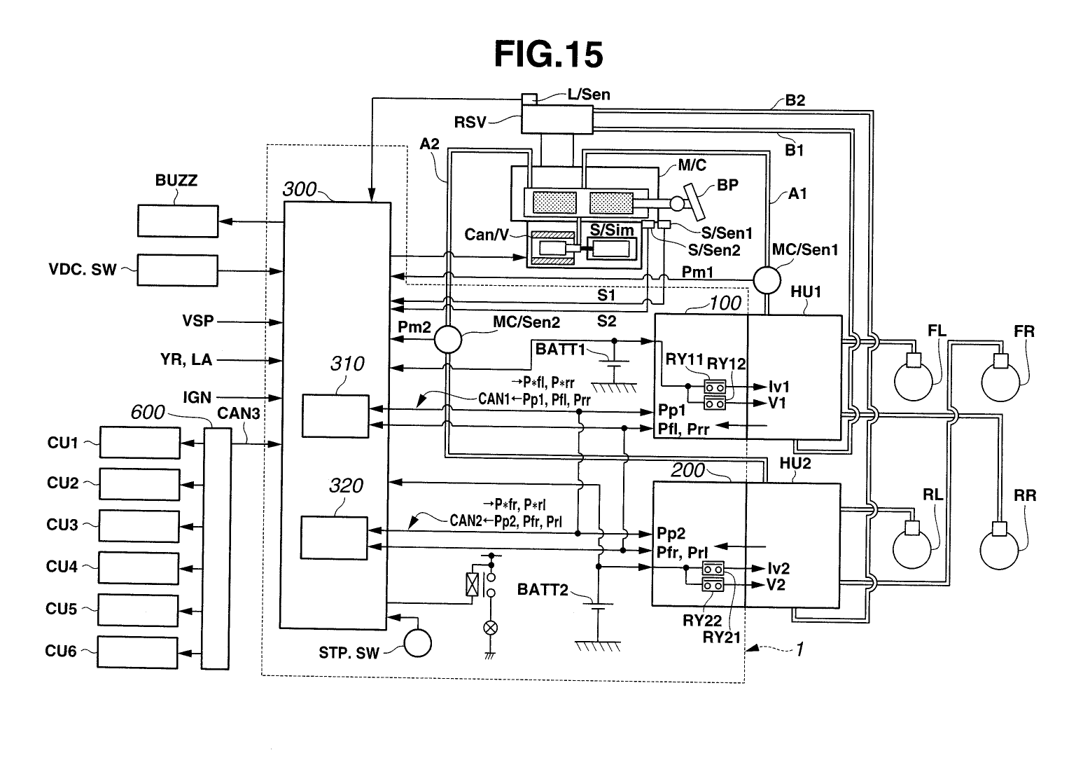

The brake control apparatus may include an integrated controller 600 as shown in FIG. 15. The integrated controller 600 governs operation of control units CU1, CU2, CU3, CU4, CU5 and CU6, and main ECU 300. The provision of integrated controller 600 requires no modification of the brake control system, because the brake control system is controlled by main ECU 300 independently of the other control systems.

Although inlet valves IN/V(FL) and IN/V(RR) in first hydraulic unit HU1 are normally closed valves in the first and second embodiments, these valves may be replaced with a construction as shown in FIG. 16 which includes normally open inlet valves IN/V(FL) and IN/V(RR) and check valves C/V(FL) and C/V(RR) arranged in fluid passages C1(FL) and C1(RR) for preventing brake fluid from inversely flowing toward first hydraulic pump P1. This is effective for reducing electric energy consumption, because check valves C/V(FL) and C/V(RR) can prevent inverse flow with no electric energy in contrast to the case where front left and rear right inlet valves IN/V(FL) and IN/V(RR) controls flow with electric energy. Second hydraulic unit HU2 may be modified similarly.

Master cylinder M/C, which is of a tandem type, supplies to first and second hydraulic units HU1 and HU2 identical hydraulic pressures which are measured by first and second master cylinder pressure sensors MC/Sen1 and MC/Sen2 provided in fluid passages A1 and A2. When one of first and second master cylinder pressure sensors MC/Sen1 and MC/Sen2 is failed, then main ECU 300 may control first and second hydraulic units HU1 and HU2 on the basis of measurement of the normal one of first and second master cylinder pressure sensors MC/Sen1 and MC/Sen2.

Main ECU 300 may compute the pressure coefficients KRm1 and KRm2 of first and second master cylinder pressure sensors MC/Sen1 and MC/Sen2 in a manner similar to the manner in which the pressure coefficients KRfl and KRfr are computed in the first calibrating operation, and memorize the ratio between the pressure coefficients KRm1 and KRm2. This ratio can be used to compute a master cylinder pressure, which is to be measured by one of first and second master cylinder pressure sensors MC/Sen1 and MC/Sen2, on the basis of the measured quantity value obtained by the other sensor, when the one of first and second master cylinder pressure sensors MC/Sen1 and MC/Sen2 is failed while the vehicle is traveling.

Suppose second master cylinder pressure sensor MC/Sen2 is failed. The pressure coefficient KRm2 can be calculated using the following equation.

KRm2=(KRm2/KRm1)·KRm1

The thus-computed pressure coefficient KRm2 is used to compute the second measured master cylinder pressure Pm2 which is used to control the controlled objects of second hydraulic unit HU2 such as front right and rear left inlet valves IN/V(FR) and IN/V(RL) and front right and rear left outlet valves OUT/V(FR) and OUT/V(RL).

First and second hydraulic units HU1 and HU2 may be replaced with an equivalent single hydraulic unit. The X-pipe arrangement may be replaced with a set of four independent brake systems for independently controlling the four wheels.

This application is based on a prior Japanese Patent Application No. 2007-259522 filed on Oct. 3, 2007. The entire contents of this Japanese Patent Application No. 2007-259522 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus comprising:
a hydraulic pressure source arranged to output a hydraulic pressure;
a wheel cylinder adapted to a wheel;
a fluid passage section hydraulically connected between the hydraulic pressure source and the wheel cylinder;
a selector arranged to regulate fluid communication through the fluid passage section between the hydraulic pressure source and the wheel cylinder;
a first pressure sensor arranged to measure a first quantity correlated to the hydraulic pressure outputted by the hydraulic pressure source;
a second pressure sensor arranged to measure a second quantity correlated to an internal pressure of the wheel cylinder; and
a controller for controlling a braking force of the wheel by the wheel cylinder, the controller being configured to:
allow the first pressure sensor to obtain a value of the first quantity, and allow the second pressure sensor to obtain a value of the second quantity, while allowing the selector to regulate fluid communication between the hydraulic pressure source and the wheel cylinder; and
calibrate the first and second pressure sensors with respect to each other in accordance with the obtained values of the first and second quantities.

2. The brake control apparatus as claimed in claim 1, wherein the controller is configured to determine that at least one of the first and second pressure sensors is failed, in response to determining that a difference between the obtained values of the first and second quantities is above a predetermined reference value.

3. The brake control apparatus as claimed in claim 2, wherein:
the hydraulic actuator includes a first hydraulic actuator and a second hydraulic actuator;
the hydraulic pressure source includes a first hydraulic pressure source and a second hydraulic pressure source;
the first hydraulic actuator includes the first hydraulic pressure source;
the second hydraulic actuator includes the second hydraulic pressure source;
the fluid passage section includes:
a first fluid passage hydraulically connecting the first hydraulic actuator to the master cylinder; and
a second fluid passage hydraulically connecting the second hydraulic actuator to the master cylinder;
the master cylinder supplies the first hydraulic actuator with a first hydraulic pressure through the first fluid passage, and supplies the second hydraulic actuator with a second hydraulic pressure through the second fluid passage; and
the first hydraulic pressure is equal to the second hydraulic pressure.

4. The brake control apparatus as claimed in claim 3, wherein:
the hydraulic pressure source is a hydraulic pump; and
the controller is configured to suspend the calibration of the first and second pressure sensors, in response to determining that a quantity of state of discharge of the hydraulic pressure source is above a predetermined reference value.

5. The brake control apparatus as claimed in claim 1, further comprising a master cylinder hydraulically connected to the fluid passage section, wherein:
the hydraulic pressure source is arranged to generate the hydraulic pressure independently of the master cylinder;
the selector constitutes a hydraulic actuator for regulating the internal pressure of the wheel cylinder; and
the controller is configured to control the internal pressure of the wheel cylinder by the hydraulic pressure source and the hydraulic actuator.

6. The brake control apparatus as claimed in claim 5, wherein:
the fluid passage section includes:
a first fluid passage hydraulically connected between the master cylinder and the wheel cylinder;
a second fluid passage hydraulically connected between the hydraulic pressure source and the wheel cylinder; and
a third fluid passage hydraulically connected between the wheel cylinder and a reservoir;
the selector includes:
a shut-off valve arranged in the first fluid passage;
an inlet valve arranged in the second fluid passage; and
an outlet valve arranged in the third fluid passage;
the first pressure sensor is arranged in the second fluid passage; and
the second pressure sensor is arranged at the wheel cylinder.

7. The brake control apparatus as claimed in claim 6, further comprising a check valve arranged between the inlet valve and the hydraulic pressure source for allowing a flow from the hydraulic pressure source to the inlet valve, and blocking a flow from the inlet valve to the hydraulic pressure source, wherein the inlet valve is a normally open valve.

8. The brake control apparatus as claimed in claim 5, wherein the hydraulic actuator includes a first hydraulic actuator and a second hydraulic actuator.

9. The brake control apparatus as claimed in claim 8, wherein:
the hydraulic pressure source includes a first hydraulic pressure source and a second hydraulic pressure source;
the first hydraulic actuator includes the first hydraulic pressure source; and
the second hydraulic actuator includes the second hydraulic pressure source.

10. The brake control apparatus as claimed in claim 9, wherein:
the fluid passage section includes:
a first fluid passage hydraulically connecting the first hydraulic actuator to the master cylinder; and
a second fluid passage hydraulically connecting the second hydraulic actuator to the master cylinder;
the master cylinder supplies the first hydraulic actuator with a first hydraulic pressure through the first fluid passage, and supplies the second hydraulic actuator with a second hydraulic pressure through the second fluid passage; and
the first hydraulic pressure is equal to the second hydraulic pressure.

11. The brake control apparatus as claimed in claim 10, wherein:
the first hydraulic actuator is arranged to regulate internal pressures of wheel cylinders adapted to front left and rear right wheels; and
the second hydraulic actuator is arranged to regulate internal pressures of wheel cylinders adapted to front right and rear left wheels.

12. The brake control apparatus as claimed in claim 9, wherein the hydraulic pressure source is a hydraulic pump.

13. The brake control apparatus as claimed in claim 12, wherein the controller is configured to suspend the calibration of the first and second pressure sensors, in response to determining that a quantity of state of discharge of the hydraulic pressure source is above a predetermined reference value.

14. The brake control apparatus as claimed in claim 13, wherein the quantity of state of discharge of the hydraulic pressure source is a rotational speed of the hydraulic pressure source.

15. The brake control apparatus as claimed in claim 9, wherein:
the fluid passage section includes:
a first fluid passage hydraulically connecting the first hydraulic actuator to the master cylinder; and
a second fluid passage hydraulically connecting the second hydraulic actuator to the master cylinder; and
the brake control apparatus further comprises:
a first master cylinder pressure sensor arranged in the first fluid passage for measuring a first hydraulic pressure outputted by the master cylinder; and
a second master cylinder pressure sensor arranged in the second fluid passage for measuring a second hydraulic pressure outputted by the master cylinder.

16. The brake control apparatus as claimed in claim 1, wherein the controller is configured to memorize a parameter set defining a general relationship between the first and second quantities.

17. The brake control apparatus as claimed in claim 16, wherein the controller is configured to memorize a default value set of the parameter set.

18. A process of operating a brake control apparatus after mounting a hydraulic actuator to a vehicle, the brake control apparatus including: a master cylinder; a first wheel cylinder adapted to a first wheel of the vehicle; a second wheel cylinder adapted to a second wheel of the vehicle; a hydraulic pump arranged to output a hydraulic pressure independently of the master cylinder; the hydraulic actuator including: a first fluid passage hydraulically connected between the master cylinder and the first wheel cylinder; a second fluid passage hydraulically connected between the hydraulic pump and the first wheel cylinder; a third fluid passage hydraulically connected between the hydraulic pump and the second wheel cylinder; a fourth fluid passage hydraulically connected between the first wheel cylinder and a reservoir; a fifth fluid passage hydraulically connected between the second wheel cylinder and the reservoir; a shut-off valve arranged in the first fluid passage; a first inlet valve arranged in the second fluid passage; a second inlet valve arranged in the third fluid passage; a first outlet valve arranged in the fourth fluid passage; and a second outlet valve arranged in the fifth fluid passage; a first pressure sensor arranged to measure a first quantity correlated to an internal pressure of the first wheel cylinder; a second pressure sensor arranged to measure a second quantity correlated to an internal pressure of the second wheel cylinder; and a controller configured to control the internal pressures of the first and second wheel cylinders by the hydraulic pump and the hydraulic actuator so as to control braking forces of the first and second wheels, the process comprising:
establishing a first condition by opening the shut-off valve, closing the first and second inlet valves, closing the first and second outlet valves, and allowing the master cylinder to be pressurized, so as to generate a hydraulic pressure in the first fluid passage;
calibrating the first pressure sensor under the first condition;
establishing a second condition by closing the shut-off valve, opening the first and second inlet valves, closing the first and second outlet valves, and driving the hydraulic pump, so as to generate a hydraulic pressure in the second and third fluid passages;
allowing the second pressure sensor to obtain a value of the second quantity under the second condition; and
calibrating the second pressure sensor with respect to the first pressure sensor in accordance with the obtained value of the second quantity.

19. A process of operating a brake control apparatus, the brake control apparatus including: a master cylinder; a first wheel cylinder adapted to a first wheel of a vehicle; a second wheel cylinder adapted to a second wheel of the vehicle; a hydraulic pump arranged to output a hydraulic pressure independently of the master cylinder; a hydraulic actuator including: a first fluid passage hydraulically connected between the master cylinder and the first wheel cylinder; a second fluid passage hydraulically connected between the hydraulic pump and the first wheel cylinder; a third fluid passage hydraulically connected between the hydraulic pump and the second wheel cylinder; a fourth fluid passage hydraulically connected between the first wheel cylinder and a reservoir; a fifth fluid passage hydraulically connected between the second wheel cylinder and the reservoir; a shut-off valve arranged in the first fluid passage; a first inlet valve arranged in the second fluid passage; a second inlet valve arranged in the third fluid passage; a first outlet valve arranged in the fourth fluid passage; and a second outlet valve arranged in the fifth fluid passage; a first pressure sensor arranged to measure a first quantity correlated to an internal pressure of the first wheel cylinder; a second pressure sensor arranged to measure a second quantity correlated to an internal pressure of the second wheel cylinder; and a controller configured to control the internal pressures of the first and second wheel cylinders by the hydraulic pump and the hydraulic actuator so as to control braking forces of the first and second wheels, the process comprising:
establishing a first condition by closing the shut-off valve, opening the first and second inlet valves, closing the first and second outlet valves, and driving the hydraulic pump, so as to generate a hydraulic pressure in the second and third fluid passages, before mounting the hydraulic actuator to the vehicle;
allowing the first pressure sensor to obtain a value of the first quantity under the first condition, and allowing the second pressure sensor to obtain a value of the second quantity under the first condition;
calibrating the first and second pressure sensors with respect to each other in accordance with the obtained values of the first and second quantities;
establishing a second condition by opening the shut-off valve, closing the first and second inlet valves, closing the first and second outlet valves, and allowing the first fluid passage to be pressurized;
allowing the first pressure sensor to obtain a second value of the first quantity under the second condition; and
recalibrating the first and second pressure sensors in accordance with the second value of the first quantity.

20. A process of operating a brake control apparatus, the brake control apparatus including: a master cylinder; a first wheel cylinder adapted to a front left wheel of a vehicle; a second wheel cylinder adapted to a front right wheel of the vehicle; a first hydraulic pump arranged to output a hydraulic pressure independently of the master cylinder; a second hydraulic pump arranged to output a hydraulic pressure independently of the master cylinder; a first hydraulic actuator including: a first fluid passage hydraulically connected between the master cylinder and the first wheel cylinder, wherein the first hydraulic actuator receives a first hydraulic pressure from the master cylinder through the first fluid passage; a second fluid passage hydraulically connected between the first hydraulic pump and the first wheel cylinder; a third fluid passage hydraulically connected between the first wheel cylinder and a reservoir; a first shut-off valve arranged in the first fluid passage; a first inlet valve arranged in the second fluid passage; and a first outlet valve arranged in the third fluid passage; a second hydraulic actuator including: a fourth fluid passage hydraulically connected between the master cylinder and the second wheel cylinder, wherein the second hydraulic actuator receives a second hydraulic pressure from the master cylinder through the fourth fluid passage, and the second hydraulic pressure is equal to the first hydraulic pressure; a fifth fluid passage hydraulically connected between the second hydraulic pump and the second wheel cylinder; a sixth fluid passage hydraulically connected between the second wheel cylinder and the reservoir; a second shut-off valve arranged in the fourth fluid passage; a second inlet valve arranged in the fifth fluid passage; and a second outlet valve arranged in the sixth fluid passage; a first pressure sensor arranged in the first fluid passage for measuring the first hydraulic pressure; a second pressure sensor arranged in the fourth fluid passage for measuring the second hydraulic pressure; and a controller configured to control the internal pressures of the first and second wheel cylinders by the hydraulic pump and the first and second hydraulic actuators so as to control braking forces of the front left and right wheels, the process comprising:
determining whether or not the first pressure sensor is failed;
controlling the first and second hydraulic actuators on a basis of measurement of the second pressure sensor, in response to determining that the first pressure sensor is failed;
determining whether or not the second pressure sensor is failed; and
controlling the first and second hydraulic actuators on a basis of measurement of the first pressure sensor, in response to determining that the second pressure sensor is failed.
